(19) United States
(12) Patent Application Publication
(10) Pub. No.: US 2025/0005731 A1
(43) Pub. Date: Jan. 2, 2025

(54) INFORMATION PROCESSING APPARATUS, INFORMATION PROCESSING METHOD, STORAGE MEDIUM, AND COMPUTER PROGRAM PRODUCT

(71) Applicant: CANON KABUSHIKI KAISHA, Tokyo (JP)

(72) Inventor: Yuji Kobayashi, Kanagawa (JP)

(21) Appl. No.: 18/756,405

(22) Filed: Jun. 27, 2024

(30) Foreign Application Priority Data
Jun. 28, 2023 (JP) 2023-106430

(51) Int. Cl. G06T 7/00

(52) U.S. Cl. CPC G06T 7/0002

(57) ABSTRACT

Some embodiments of an information processing apparatus comprise a processor and a memory containing instructions. When executed by the processor, the instructions cause the processor to identify a common portion and a different portion between first deformation data of an object and second deformation data of the object different from the first deformation data, and acquire, based on the common portion and the different portion, third deformation data having, as a legend classification, a deformation progress state between the first deformation data and the second deformation data.

### BACKGROUND

### Field of the Disclosure

The present disclosure relates to an information processing apparatus, an information processing method, a storage medium, and a computer program product.

### Description of the Related Art

A method for detecting deformations, such as cracks, from captured images of, for example, the walls of concrete structures (objects) to be inspected has been proposed. In this case, improved computer performance and detection performance have made it possible to automatically detect deformations from the images. Methods have also been proposed for determining changes in the states of deformations, such as deformation development or disappearance, from images captured at different times.

International Publication No. 2019/021729 describes a technique for performing deformation detection using captured segment images of the surface of a relatively large structure (object), such as a concrete structure, and generating a deformation diagram by combining the deformation detection results on the basis of the combined corresponding points for when the captured segment images are combined.

Japanese Patent Laid-Open No. 2019-211277 describes a technique for comparing first deformation data generated from a first image with second deformation data generated from a second image, the first and second images being captured at different times, to determine changes in the states of deformations, such as the lengths and widths of deformations.

The technique described in International Publication No. 2019/021729 and the technique described in Japanese Patent Laid-Open No. 2019-211277 do not consider errors that may occur due to ambiguities that may arise when detecting deformations or determining changes in the states of deformations. Thus, it is difficult to properly grasp the states of deformations of an object using existing techniques.

### SUMMARY

The present disclosure provides a technique that makes it possible to properly grasp the states of deformations of an object.

An aspect of an information processing apparatus according to the present disclosure includes a processor and a memory containing instructions. When executed by the processor, the instructions cause the processor to identify a common portion and a different portion between first deformation data of an object and second deformation data of the object different from the first deformation data, and acquire, based on the common portion and the different portion, third deformation data having, as a legend classification, a deformation progress state between the first deformation data and the second deformation data.

Further features of various embodiments will become apparent from the following description of exemplary embodiments with reference to the attached drawings.

### BRIEF DESCRIPTION OF THE DRAWINGS

FIG. 1 is a diagram illustrating an example of a hardware configuration of an information processing apparatus according to an embodiment of the present disclosure.

FIG. 2 is a diagram illustrating an example of a software configuration of the information processing apparatus according to the embodiment of the present disclosure.

FIG. 3A is a diagram illustrating an example of a first deformation image illustrated in FIG. 2.

FIG. 3B is a diagram illustrating an example of a second deformation image illustrated in FIG. 2.

FIG. 4A is a diagram illustrating an example of first deformation data illustrated in FIG. 2.

FIG. 4B is a diagram illustrating an example of second deformation data illustrated in FIG. 2.

FIG. 5A is a diagram depicted by visualizing first difference determination data obtained by determining, as differences, changes to the second deformation data illustrated in FIG. 4B relative to the first deformation data illustrated in FIG. 4A.

FIG. 5B is a diagram depicted by visualizing second difference determination data obtained by determining, as differences, changes to the first deformation data illustrated in FIG. 4A relative to the second deformation data illustrated in FIG. 4B.

FIG. 6 is a diagram illustrating an example of a deformation diagram of third deformation data generated from the first difference determination data illustrated in FIG. 5A and the second difference determination data illustrated in FIG. 5B.

FIG. 7 is a diagram illustrating an example of a deformation diagram confirmation-correction operation display screen displayed on a display output device illustrated in FIG. 1.

FIG. 8A is a diagram illustrating a first display example of the deformation diagram confirmation-correction operation display screen displayed on the display output device illustrated in FIG. 1.

FIG. 8B is a diagram illustrating a second display example of the deformation diagram confirmation-correction operation display screen displayed on the display output device illustrated in FIG. 1.

FIG. 8C is a diagram illustrating a third display example of the deformation diagram confirmation-correction operation display screen displayed on the display output device illustrated in FIG. 1.

FIG. 8D is a diagram illustrating a fourth display example of the deformation diagram confirmation-correction operation display screen displayed on the display output device illustrated in FIG. 1.

FIG. 8E is a diagram illustrating a fifth display example of the deformation diagram confirmation-correction operation display screen displayed on the display output device illustrated in FIG. 1.

FIG. 8F is a diagram illustrating a sixth display example of the deformation diagram confirmation-correction operation display screen displayed on the display output device illustrated in FIG. 1.

FIGS. 9A to 9J are diagrams illustrating examples of deformation correspondence candidate patterns that may be displayed in a display region on the deformation diagram confirmation-correction operation display screen displayed on the display output device illustrated in FIG. 1.

FIG. 10A is a diagram illustrating an example of the structure of a first deformation data table that stores the first deformation data illustrated in FIG. 4A.

FIG. 10B is a diagram illustrating an example of the structure of a second deformation data table that stores the second deformation data illustrated in FIG. 4B.

FIG. 11A is a diagram illustrating an example of a first difference determination table that stores a data structure of the first difference determination data illustrated in FIG. 5A.

FIG. 11B is a diagram illustrating an example of a second difference determination table that stores a data structure of the second difference determination data illustrated in FIG. 5B.

FIG. 12 is a diagram illustrating an example of a depiction obtained by enlarging the deformation data illustrated in FIGS. 4A and 10A.

FIG. 13A is a diagram illustrating an example of a depiction obtained by enlarging difference determination data (deformation data) having a deformation ID of “4117” in the first difference determination table illustrated in FIG. 11A.

FIG. 13B is a diagram illustrating an example of a depiction obtained by enlarging difference determination data (deformation data) having deformation IDs of “4218” and “4219” in the second difference determination table illustrated in FIG. 11B.

FIG. 14 is a diagram illustrating an example of a depiction obtained by enlarging combined deformation data indicated by signs 6115 to 6123 included in the deformation diagram illustrated in FIG. 6.

FIGS. 15A and 15B are diagrams illustrating an example of a deformation diagram data table that stores a data structure of the deformation diagram illustrated in FIG. 6.

FIG. 16 is a diagram illustrating an embodiment of the present disclosure and is a diagram illustrating an example of a legend table.

FIG. 17 is a diagram illustrating an example of arrangement of first deformations recorded in the first deformation data illustrated in FIG. 4A and second deformations recorded in the second deformation data illustrated in FIG. 4B in the same coordinate system.

FIG. 18 is a flowchart illustrating an example of a processing procedure of deformation diagram generating-editing processing included in an information processing method performed by the information processing apparatus according to the embodiment of the present disclosure.

FIG. 19 is a flowchart illustrating an example of a detailed processing procedure of difference determination processing in Step S1802 of FIG. 18.

FIG. 20 is a flowchart illustrating an example of a detailed processing procedure of deformation diagram generation processing in Step S1803 of FIG. 18.

### DESCRIPTION OF THE EMBODIMENTS

In the following, embodiments for implementing the present disclosure (embodiments of the present disclosure) will be described with reference to the drawings. Note that some embodiments of the present disclosure are not limited to the embodiments described below. Although multiple features are described in the embodiments of the present disclosure described below, not all of these multiple features are always essential, and these multiple features may be combined freely. Furthermore, in each drawing, identical or substantially the same constructional elements are marked with the same signs, and redundant descriptions are omitted as appropriate. Moreover, in each drawing, some constructional elements that are not important for the description are omitted.

In the embodiments of the present disclosure, for example, a computer device operates as an information processing apparatus. In the embodiments of the present disclosure, changes in the states of deformations of an object detected from images of the object captured at different times are determined, such as a new occurrence of a deformation, stretching of a deformation, widening of a deformation, an undetected deformation due to image defects, and disappearance of a deformation due to repair. Furthermore, the embodiments of the present disclosure describe an example of generating a proper deformation diagram by displaying the possibility of occurrence of errors in the deformation diagram on a display unit, so that such errors can be corrected.

Note that, in the embodiments of the present disclosure, a “deformation” refers to, for example, a crack occurring on the surface of an object due to damage, deterioration, or other factors of the object. Examples of the object include concrete structures, such as motorways, bridges, tunnels, and dams. A “crack” is a linear damage having a start point, end point, length, and width that occurs on the surface of an object (for example, a wall of a structure) due to, for example, deterioration over time or seismic impact.

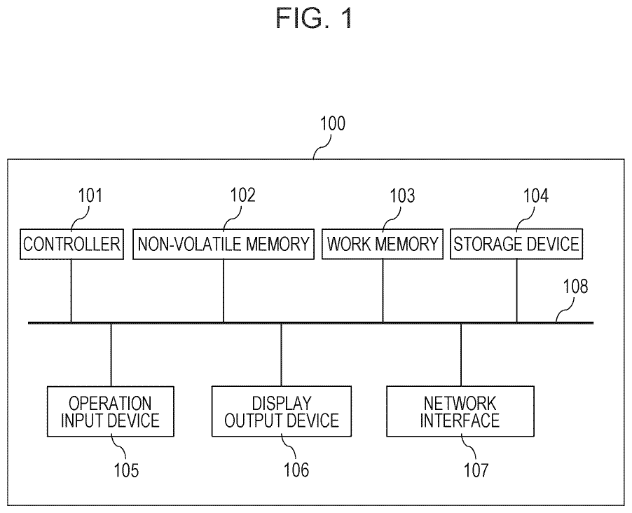

FIG. 1 is a diagram illustrating an example of a hardware configuration of an information processing apparatus 100 according to an embodiment of the present disclosure. In the present embodiment, a computer device operates as the information processing apparatus 100 as described above. In this case, processing performed by the information processing apparatus 100 may be realized by a single computer device or each function of the processing may be distributed among multiple computer devices as necessary to realize the processing. In addition, in this case, the multiple computer devices are connected to each other such that communication is possible therebetween.

The information processing apparatus 100 includes a controller 101, a non-volatile memory 102, a work memory 103, a storage device 104, an operation input device 105, a display output device 106, a network interface 107, and a system bus 108, which are hardware configurations.

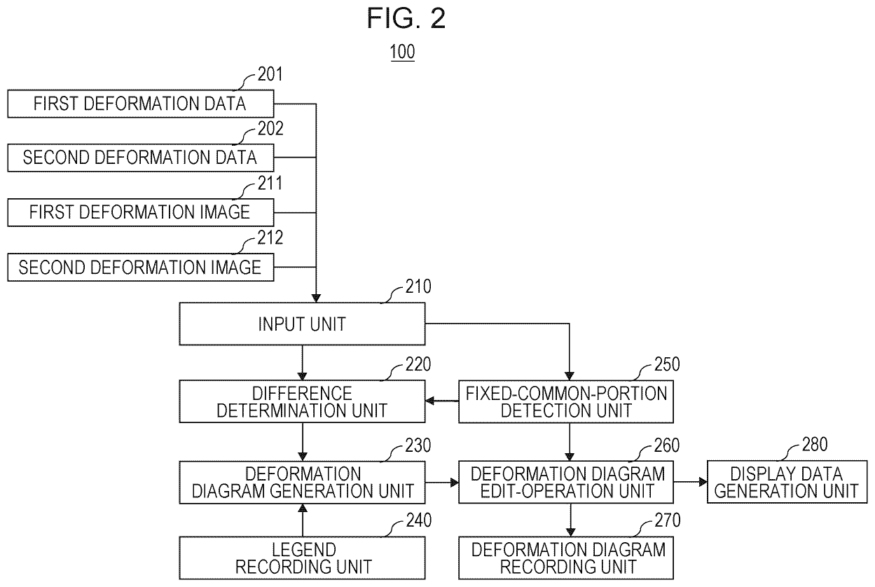

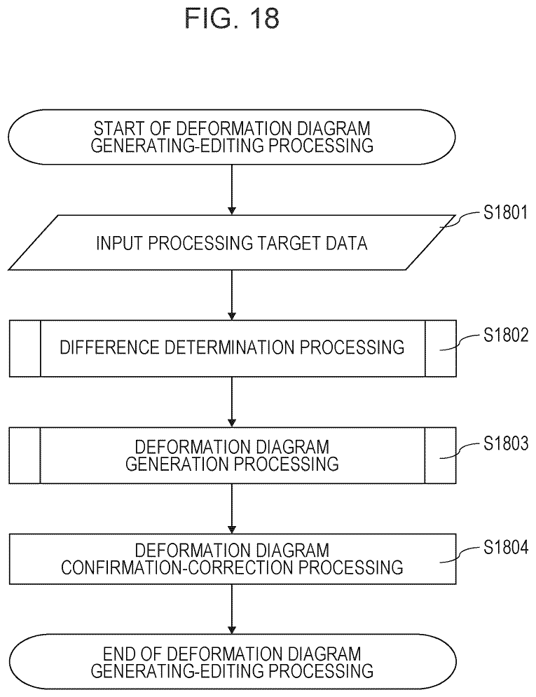

The controller 101 includes a processor for arithmetic processing, such as a central processing unit (CPU) or microprocessing unit (MPU), that has control over the entire information processing apparatus 100. The non-volatile memory 102 is a read-only memory (ROM) that stores a program executed by the processor of the controller 101 and parameters. In this case, the program realizes the software configuration (FIG. 2) of the information processing apparatus 100 to be described below and also causes the processor to execute processing steps illustrated in the flowchart (FIGS. 18 to 20) of an information processing method to be described below. The work memory 103 is a random access memory (RAM) that temporarily stores programs and data supplied from external devices and other devices. The storage device 104 is an internal device, such as a hard disk or memory card, built into the information processing apparatus 100 or an external device, such as a hard disk or memory card, connected to the information processing apparatus 100 in a detachable manner. This storage device 104 includes a memory card, a hard disk, or other devices constituted by, for example, a semiconductor memory or a magnetic disk. The storage device 104 also includes a storage medium constituted by a disk drive that reads/writes data from/to an optical disk, such as a DVD or Blu-ray® Disc.

The operation input device 105 includes operation members, such as a mouse, keyboard, and touch panel, that accept operation inputs from the user and output operation inputs (instructions) from the user to the controller 101. The display output device 106 is a display device (a display unit), such as a liquid crystal display (LCD), an LCD monitor, or an organic electroluminescent (EL) display or monitor, and displays data held by the information processing apparatus 100, data supplied from external devices, and other data. The network interface 107 connects communicatively to networks, such as the Internet and a local area network (LAN). The system bus 108 includes address buses, data buses, and control buses that connect each hardware configuration (101 to 107) of the information processing apparatus 100 so that data can be exchanged.

Note that the non-volatile memory 102 stores the operating system (OS), which is the basic software executed by the controller 101, and applications that work with this OS to realize applied functions. In the present embodiment, the non-volatile memory 102 also stores an application for the information processing apparatus 100 to realize deformation diagram generation processing to be described below.

The processing performed by the information processing apparatus 100 according to the present embodiment is realized by loading software provided by an application. Suppose that the application has software to use the basic functions of the OS installed in the information processing apparatus 100. The OS of the information processing apparatus 100 may have software to realize processing in the present embodiment.

FIG. 2 is a diagram illustrating an example of the software configuration of the information processing apparatus 100 according to an embodiment of the present disclosure. The information processing apparatus 100 has, as processing target data, first deformation data 201 and second deformation data 202 of an object and a first deformation image 211 and a second deformation image 212 of the object. Note that the first and second deformation data 201 and 202 of the object are different deformation data in the embodiment of the present disclosure. For example, the first and second deformation data 201 and 202 of the object are deformation data of the object acquired at different times. For example, the second deformation data 202 was acquired later in time than the first deformation data 201. Moreover, the first deformation image 211 of the object is an image corresponding to the first deformation data 201, and the second deformation image 212 of the object is an image corresponding to the second deformation data 202. The information processing apparatus 100 includes an input unit 210, a difference determination unit 220, a deformation diagram generation unit 230, a legend recording unit 240, a fixed-common-portion detection unit 250, a deformation diagram edit-operation unit 260, a deformation diagram recording unit 270, and a display data generation unit 280, which are software configurations.

The input unit 210 receives the first and second deformation data 201 and 202, which are processing target data, and the first deformation image 211 and second deformation image 212.

The difference determination unit 220 compares the first deformation data 201 with the second deformation data 202 by associating the first deformation data 201 and second deformation data 202 with each other on the basis of the positional identities of deformation records stored in each of the first deformation data 201 and second deformation data 202 of the object input to the input unit 210. The difference determination unit 220 performs, on the basis of the comparison result, processing for determining a common portion and a different portion between the first deformation data and second deformation data of the object to determine the differences between the first deformation data 201 and the second deformation data 202. In this case, the difference determination unit 220 that performs processing for identifying the common portion and different portion between the first deformation data and second deformation data of the object constitutes an “identification unit” in the embodiment of the present disclosure.

The deformation diagram generation unit 230 performs processing for combining the common portion and different portion between the first deformation data and second deformation data of the object obtained as a result of the difference determination made by the difference determination unit 220 to generate and acquire a deformation diagram of third deformation data. For example, the deformation diagram generation unit 230 combines the difference determination data of the second deformation data 202 relative to the first deformation data 201 and the difference determination data of the first deformation data 201 relative to the second deformation data 202 to generate and acquire a deformation diagram, the difference determination data having been acquired by the difference determination unit 220. In this case, the deformation diagram generation unit 230 that performs processing for generating and acquiring a deformation diagram of third deformation data constitutes an “acquisition unit” in the embodiment of the present disclosure.

The legend recording unit 240 holds information that defines the recording format of a deformation diagram of third deformation data generated by the deformation diagram generation unit 230, and is referenced when a deformation diagram of third deformation data is generated by the deformation diagram generation unit 230.

The fixed-common-portion detection unit 250 performs processing for detecting depicted items other than visible deformations (common portions that do not include a deformation (fixed common portions)), the depicted items being present in both the first deformation image 211 and the second deformation image 212 input to the input unit 210. The fixed-common-portion detection unit 250 that performs processing for detecting common portions that do not include a deformation (a fixed common portion) constitutes a “detection unit”.

The deformation diagram edit-operation unit 260 displays a deformation diagram of the third deformation data, acquired by the deformation diagram generation unit 230, on the display output device 106, which is the display unit, via the display data generation unit 280. As a result, the deformation diagram edit-operation unit 260 makes it possible to display potential error portions and provides a function that allows the user to select a correct deformation correspondence between the first deformation data 201 and the second deformation data 202.

The deformation diagram recording unit 270 stores deformation diagrams edited (including corrections and changes) by the deformation diagram edit-operation unit 260.

The display data generation unit 280 performs processing for generating display data based on the deformation diagram edited (including corrections and changes) by the deformation diagram edit-operation unit 260 and displaying the display data on the display output device 106, which is the display unit.

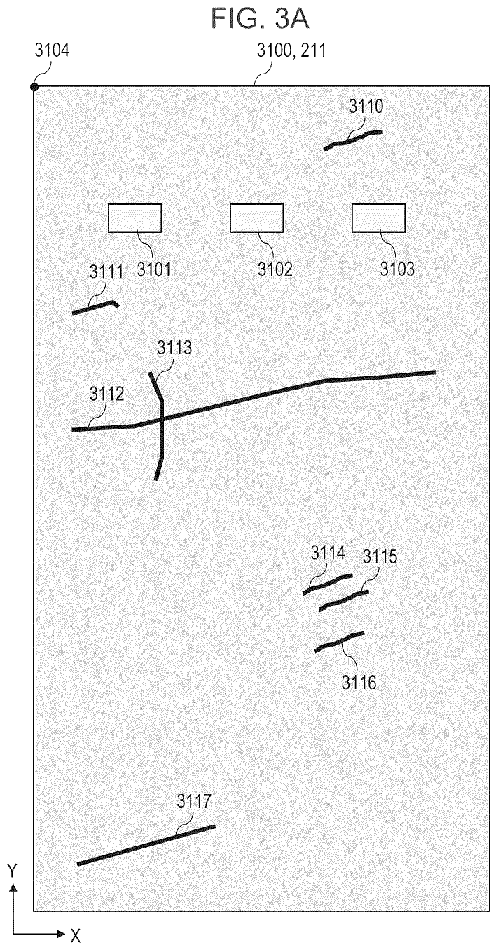

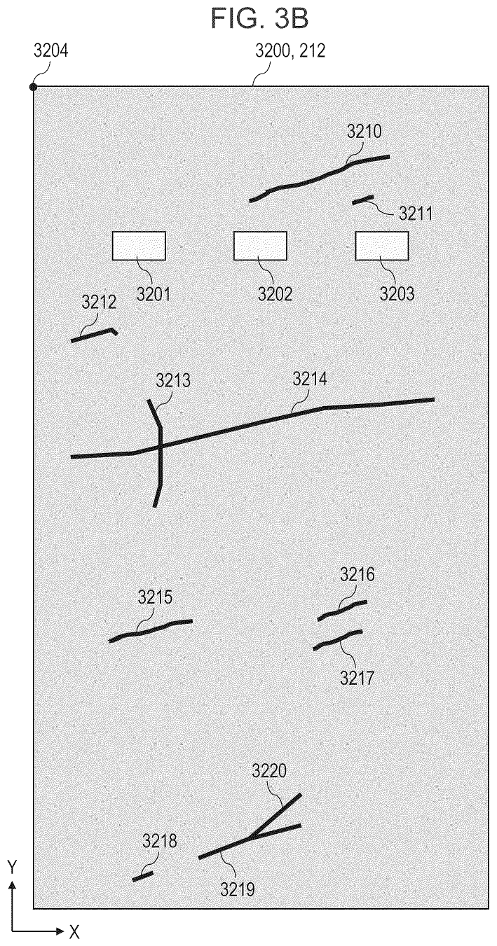

FIG. 3A is a diagram illustrating an example of the first deformation image 211 illustrated in FIG. 2. In FIG. 3A, the first deformation image 211 illustrated in FIG. 2 is illustrated as a first deformation image 3100. FIG. 3B is a diagram illustrating an example of the second deformation image 212 illustrated in FIG. 2. In FIG. 3B, the second deformation image 212 illustrated in FIG. 2 is illustrated as a second deformation image 3200. The first deformation image 3100 illustrated in FIG. 3A and the second deformation image 3200 illustrated in FIG. 3B may be, for example, images obtained by depicting the entire wall surface of a structure (an object) or part of the wall surface of the structure. In the present embodiment, the first deformation image 3100 illustrated in FIG. 3A and the second deformation image 3200 illustrated in FIG. 3B illustrate examples of images obtained by capturing the inner wall surface of a road tunnel, which is an object. More specifically, the first deformation image 3100 illustrated in FIG. 3A and the second deformation image 3200 illustrated in FIG. 3B are partial images divided by span, which is the unit of lining of the inner wall of the road tunnel, the object. Regions 3101, 3102, and 3103 of the first deformation image 3100 illustrated in FIG. 3A schematically illustrate lighting devices and other items installed on the inner wall lining of the road tunnel, the object. The regions 3101, 3102, and 3103 illustrated in FIG. 3A represent the same installed items that are fixed common portions as regions 3201, 3202, and 3203 illustrated in FIG. 3B, respectively. A point 3104 illustrated in FIG. 3A indicates the origin coordinates (0, 0) of the first deformation image 3100, and a point 3204 illustrated in FIG. 3B indicates the origin coordinates (0, 0) of the second deformation image 3200. Furthermore, deformations 3110 to 3117 illustrated in FIG. 3A and deformations 3210 to 3220 illustrated in FIG. 3B each represent a crack deformation of the inner wall lining of the road tunnel, the object.

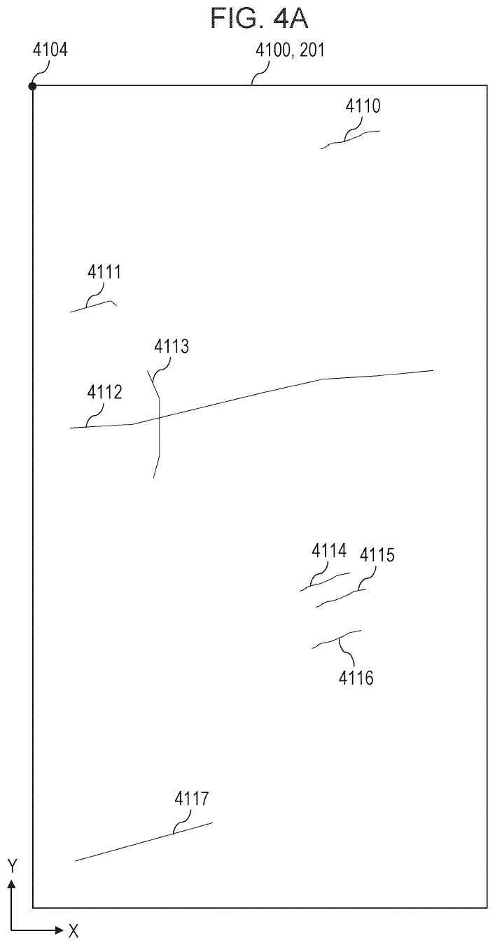

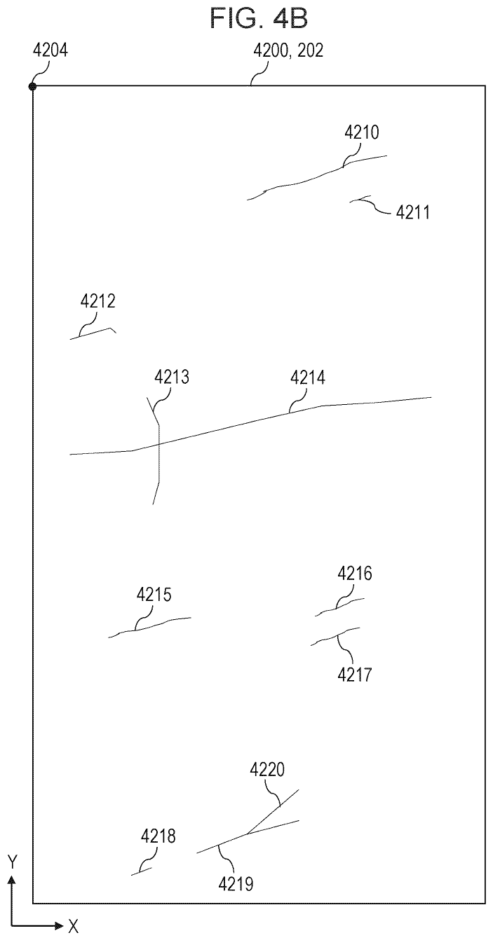

FIG. 4A is a diagram illustrating an example of the first deformation data 201 illustrated in FIG. 2. In FIG. 4A, the first deformation data 201 illustrated in FIG. 2 is illustrated as first deformation data 4100. Specifically, the first deformation data 4100 illustrated in FIG. 4A is a diagram depicted by visualizing the deformation data of only deformation portions detected from the first deformation image 3100 illustrated in FIG. 3A. In the first deformation data 4100 illustrated in FIG. 4A, the crack deformations 3110 to 3117 illustrated in FIG. 3A are recorded as deformation data 4110 to 4117, respectively. Moreover, a point 4104 illustrated in FIG. 4A corresponds to the point 3104 illustrated in FIG. 3A.

FIG. 4B is a diagram illustrating an example of the second deformation data 202 illustrated in FIG. 2. In FIG. 4B, the second deformation data 202 illustrated in FIG. 2 is illustrated as second deformation data 4200. Specifically, the second deformation data 4200 illustrated in FIG. 4B is a diagram depicted by visualizing the deformation data of only deformation portions detected from the second deformation image 3200 illustrated in FIG. 3B. In the second deformation data 4200 illustrated in FIG. 4B, the crack deformations 3210 to 3220 illustrated in FIG. 3B are recorded as deformation data 4210 to 4220, respectively. Moreover, a point 4204 illustrated in FIG. 4B corresponds to the point 3204 illustrated in FIG. 3B.

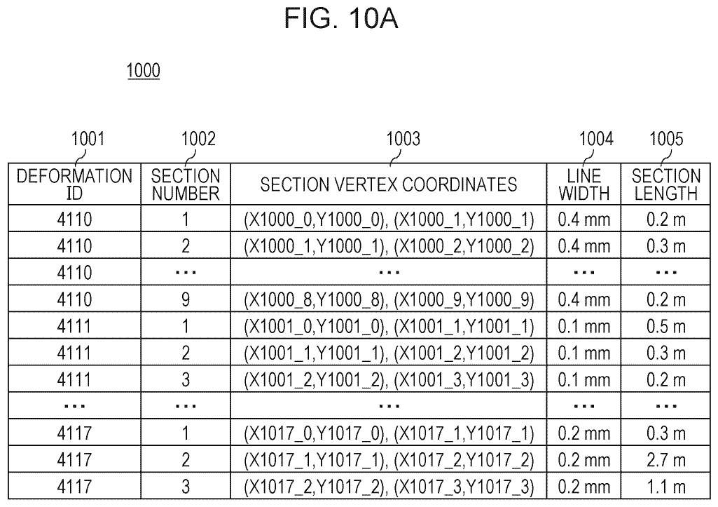

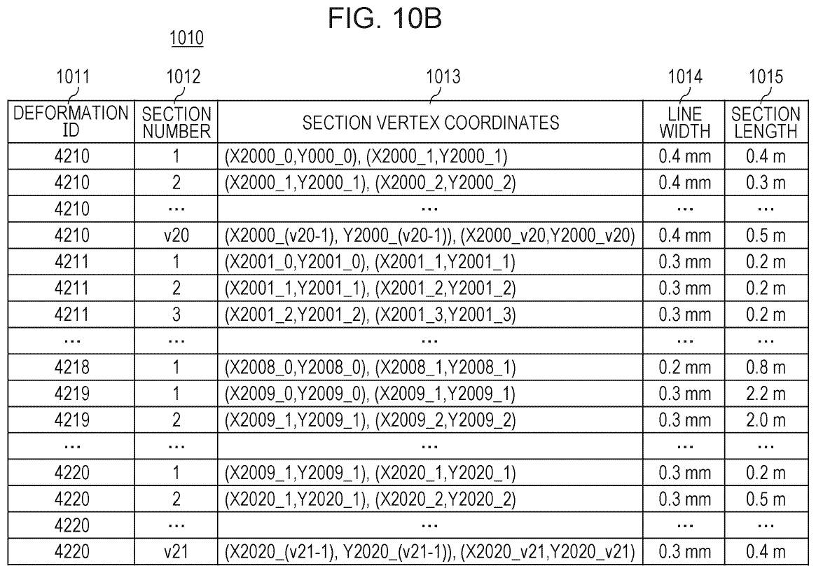

FIG. 10A is a diagram illustrating an example of the structure of a first deformation data table 1000, which stores the first deformation data 4100 illustrated in FIG. 4A. In the first deformation data table 1000, as illustrated in FIG. 10A, deformation IDs 1001, section numbers 1002, section vertex coordinates 1003, line widths 1004, and section lengths 1005 are recorded for the deformation data 4110 to 4117 illustrated in FIG. 4A. The deformation IDs 1001 are information for uniquely identifying the individual deformation data. The section numbers 1002 are information indicating the section numbers of the deformation data. The section vertex coordinates 1003 are information indicating, for each section, the coordinates of two vertices, which are end points of the section. The line widths 1004 are information indicating the line widths of the sections. The section lengths 1005 are information indicating the lengths of the sections. In the first deformation data table 1000 illustrated in FIG. 10A, the line widths 1004 and section lengths 1005 store information on the actual distances (e.g., in millimeters or meters) calculated from the image resolution. In the first deformation data table 1000 illustrated in FIG. 10A, each deformation data can be input by the user using, for example, a tablet to trace the deformation on the image, can be automatically generated by image analysis processing or the like, or can be input using a combination of these methods. The image analysis processing may be performed using a learning model generated by artificial intelligence (AI) machine learning and deep learning. The measurement or estimation of the line widths 1004 can also be performed using learning models generated by machine learning and deep learning.

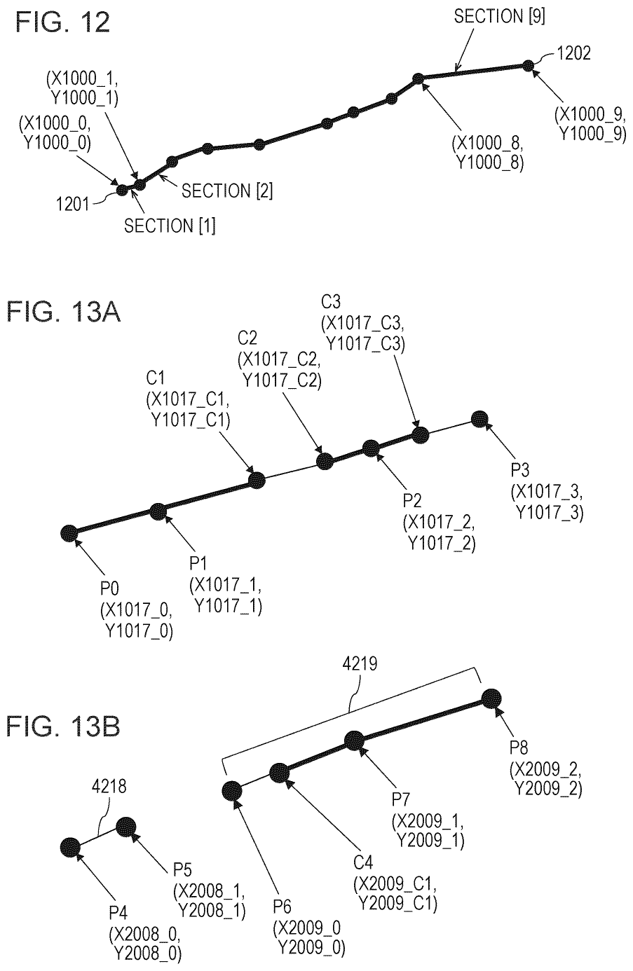

FIG. 12 is a diagram illustrating an example of a depiction obtained by enlarging the deformation data 4110 illustrated in FIGS. 4A and 10A. A crack deformation is expressed as vector data and is constituted by line segments connecting vertices. In FIG. 12, the deformation data 4110 is constituted by 10 vertices and 9 section line segments connecting between the vertices. Each vertex illustrated in FIG. 12 is identified by X and Y coordinates in the image coordinate system with the point 3104 in FIG. 3A (and also the point 4104 in FIG. 4A) as the origin coordinates (0, 0). An end point 1201 illustrated in FIG. 12 has an X coordinate value of X1000_0 and a Y coordinate value of Y1000_0. The other end point 1202 has an X coordinate value of X1000_9 and a Y coordinate value of Y1000_9. The above-described case of the deformation data 4110 can be applied similarly to the other deformation data 4111 to 4117 illustrated in FIGS. 4A and 10A.

FIG. 10B is a diagram illustrating an example of the structure of a second deformation data table 1010, which stores the second deformation data 4200 illustrated in FIG. 4B. In the second deformation data table 1010, as illustrated in FIG. 10B, deformation IDs 1011, section numbers 1012, section vertex coordinates 1013, line widths 1014, and section lengths 1015 are recorded for the deformation data 4210 to 4220 illustrated in FIG. 4B. The deformation IDs 1011, section numbers 1012, section vertex coordinates 1013, line widths 1014, and section lengths 1015 illustrated in FIG. 10B are substantially the same as the deformation IDs 1001, section numbers 1002, section vertex coordinates 1003, line widths 1004, and section lengths 1005 illustrated in FIG. 10A, respectively. The deformation data having a deformation ID 1011 of “4210” illustrated in FIG. 10B is constituted by (V20+1) vertices and partial sections corresponding to (V20) section line segments.

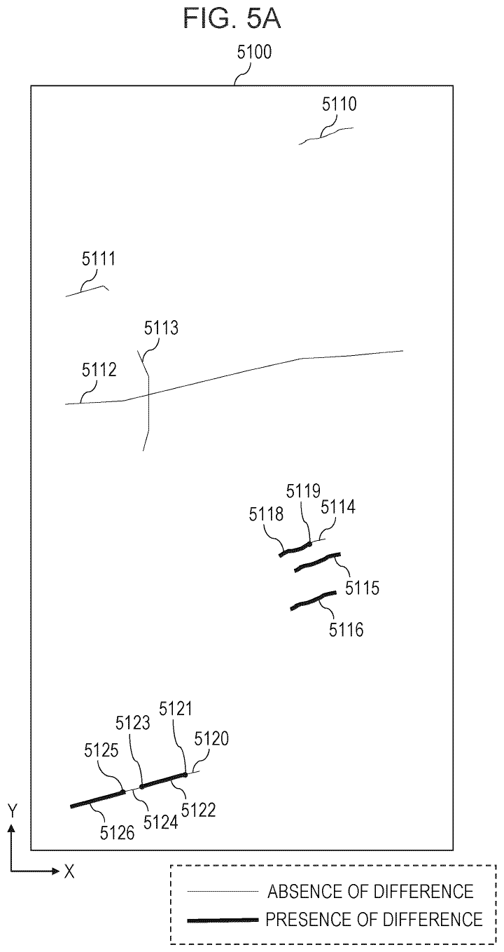

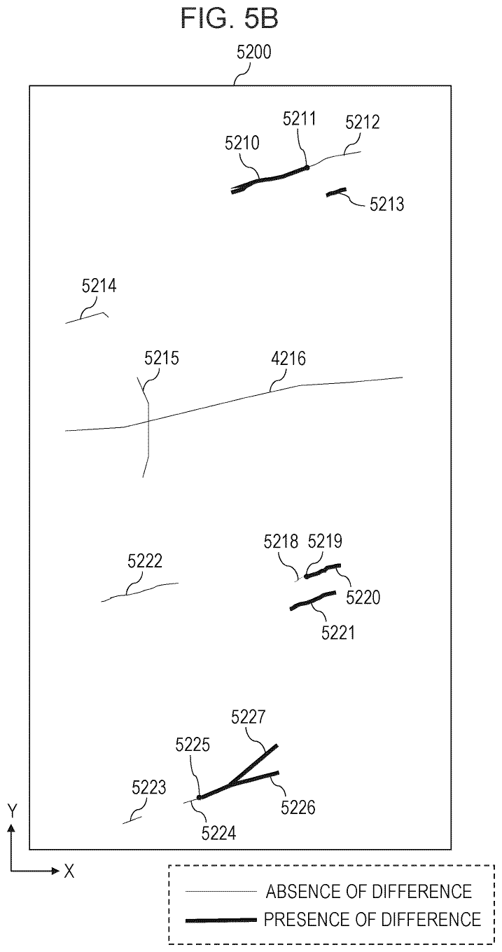

FIG. 5A is a diagram depicted by visualizing first difference determination data 5100 obtained by determining, as differences, changes to the second deformation data 4200 illustrated in FIG. 4B relative to the first deformation data 4100 illustrated in FIG. 4A. FIG. 5B is a diagram depicted by visualizing second difference determination data 5200 obtained by determining, as differences, changes to the first deformation data 4100 illustrated in FIG. 4A relative to the second deformation data 4200 illustrated in FIG. 4B. The first difference determination data 5100 illustrated in FIG. 5A and the second difference determination data 5200 illustrated in FIG. 5B are processed, for example, by the difference determination unit 220.

In the first difference determination data 5100 illustrated in FIG. 5A and the second difference determination data 5200 illustrated in FIG. 5B, the results determined based on whether or not a corresponding deformation section exists for each partial section of each deformation data are represented as the widths of depicted solid lines. Specifically, in FIGS. 5A and 5B, fine lines indicate “absence of difference” and thick lines indicate “presence of difference”. For example, the depicted lines to which signs 5115, 5116, 5118, 5122, and 5126 are assigned in FIG. 5A are thick lines and are thus partial sections where differences have occurred (presence of differences). As the depiction style for determining the presence or absence of differences, other identifiable display forms may be used, such as other line types or other line colors. Moreover, the vertices to which signs 5119, 5121, 5123, and 5125 are assigned in FIG. 5A indicate end points of the sections where differences have occurred.

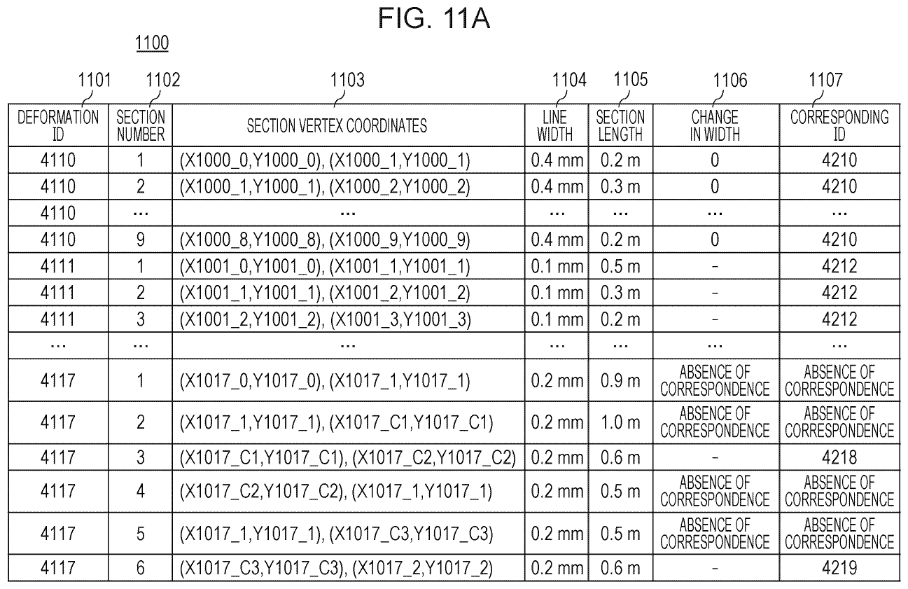

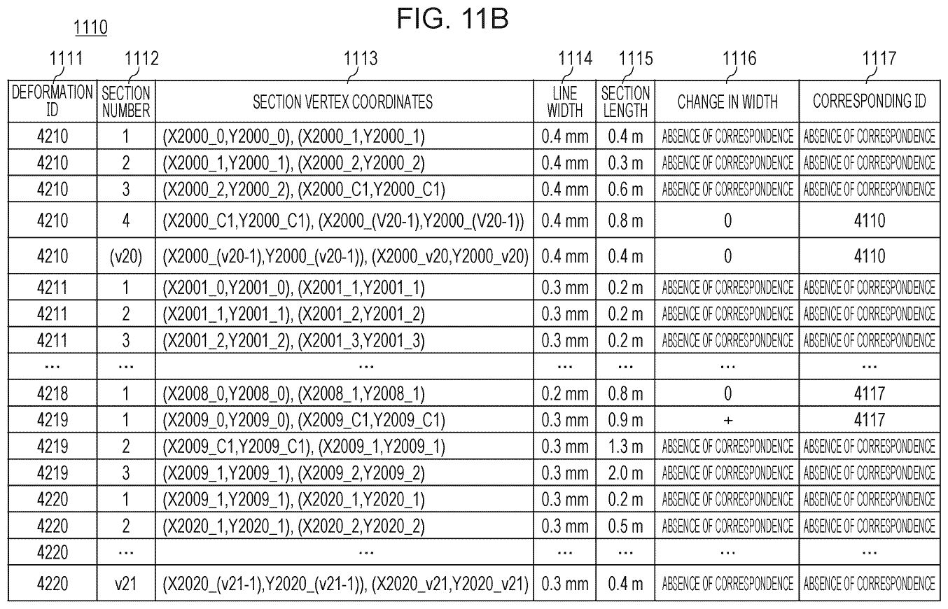

FIG. 11A is a diagram illustrating an example of a first difference determination table 1100 that stores a data structure of the first difference determination data 5100 illustrated in FIG. 5A. Since the first difference determination data 5100 illustrated in FIG. 5A uses the first deformation data 4100 illustrated in FIG. 4A as a reference, the first difference determination table 1100 illustrated in FIG. 11A stores deformation IDs 1101 of the first deformation data 4100 illustrated in FIG. 4A. The first difference determination table 1100 illustrated in FIG. 11A records, in addition to the deformation IDs 1101, section numbers 1102, section vertex coordinates 1103, line widths 1104, section lengths 1105, changes in width 1106 and corresponding IDs 1107. In this case, the changes in width 1106 are information indicating changes (differences) in the section widths. The corresponding IDs 1107 are information indicating deformation IDs of the deformation data determined to be at the same position.

FIG. 11B is a diagram illustrating an example of a second difference determination table 1110 that stores a data structure of the second difference determination data 5200 illustrated in FIG. 5B. Since the second difference determination data 5200 illustrated in FIG. 5B uses the second deformation data 4200 illustrated in FIG. 4B as a reference, the second difference determination table 1110 illustrated in FIG. 11B stores deformation IDs 1111 of the second deformation data 4200 illustrated in FIG. 4B. The second difference determination table 1110 illustrated in FIG. 11B records, in addition to the deformation IDs 1111, section numbers 1112, section vertex coordinates 1113, line widths 1114, section lengths 1115, changes in width 1116 and corresponding IDs 1117.

In the first difference determination table 1100 of FIG. 11A, in a case where a section has the same section vertex coordinates 1003 of a section in the first deformation data table 1000, the line width 1104 and the section length 1105 of the section are the same as the line width and the section length, respectively, of the same section in the first deformation data table 1000. Moreover, in a case where the section has a different section vertex coordinate, the first difference determination table 1100 illustrated in FIG. 11A stores the average of line width values of adjacent sections as the line width 1104. In the first difference determination table 1100 illustrated in FIG. 11A, in a case where a section that matches a corresponding deformation data indicated by the corresponding ID 1107 is not present, “absence of correspondence” is stored in the change in width 1106 and the corresponding ID 1107. In FIG. 11A, in a case where a section that matches a corresponding deformation data indicated by the corresponding ID 1107 is present, “−” (minus) is stored when the value obtained by subtracting the value of the line width 1114 from that of the line width 1104 is a negative value, “0” (zero) is stored when the value is 0, and “+” (plus) is stored when the value is a positive value.

Similarly to the above-described case of the first difference determination table 1100 illustrated in FIG. 11A, substantially the same structure applies to the second difference determination table 1110 illustrated in FIG. 11B. In the second difference determination table 1110 illustrated in FIG. 11B, change values determined based on the values obtained by subtracting the values of the line widths 1104 from those of the line widths 1114 are stored in the changes in width 1116.

The first difference determination table 1100 illustrated in FIG. 11A and the second difference determination table 1110 illustrated in FIG. 11B store all the difference determination data expressed as a depiction in FIG. 5A and that in FIG. 5B, respectively.

FIG. 13A is a diagram illustrating an example of a depiction obtained by enlarging the difference determination data denoted by signs 5120 to 5126 illustrated in FIG. 5A. Specifically, FIG. 13A is a diagram illustrating an example of a depiction obtained by enlarging the difference determination data (deformation data) having a deformation ID 1101 of “4117” in the first difference determination table 1100 illustrated in FIG. 11A. As illustrated in the first difference determination table 1100 in FIG. 11A, the difference determination data having a deformation ID 1101 of “4117” is constituted by seven vertices and six sections. The vertices P0, P1, P2, and P3 illustrated in FIG. 13A are vertices recorded in the difference determination data (deformation data) having a deformation ID 1101 of “4117”, and the vertices C1, C2, and C3 are vertices that specify corresponding matching sections. The section connected by the vertices C1-C2 illustrated in FIG. 13A and the section connected by the vertices C3-P3 illustrated in FIG. 13A are corresponding matching sections.

FIG. 13B is a diagram illustrating an example of a depiction obtained by enlarging the difference determination data (deformation data) having deformation IDs 1111 of “4218” and “4219” in the second difference determination table 1110 illustrated in FIG. 11B. The difference determination data having a deformation ID 1111 of “4218” illustrated in FIG. 13B is determined to match part of the difference determination data having a deformation ID 1111 of “4117” and is thus depicted using a fine line. Moreover, the difference determination data having a deformation ID 1111 of “4219” illustrated in FIG. 13B is constituted by four vertices and three sections. In the difference determination data having a deformation ID 1111 of “4219” illustrated in FIG. 13B, the section formed by connecting the vertices P6-C4 matches the section having a deformation ID of 4117 and is depicted using a fine line. The two sections formed by connecting the vertices C4-P7-P8 are depicted as sections with differences using thick lines.

The example illustrated in FIG. 11A illustrates that the difference determination data having a deformation ID 1101 of “4110” corresponds to the data having a deformation ID 1011 of “4210” and stored in the second deformation data table 1010 illustrated in FIG. 10B. The example illustrated in FIG. 11A illustrates that the difference determination data having a deformation ID 1101 of “4110” matches the data having a deformation ID 1011 of “4210” without any change in width since the values in the changes in width 1106 are “0”. The first difference determination table 1100 illustrated in FIG. 11A stores difference determination results only for the section data recorded in the first deformation data 4100 illustrated in FIG. 4A, and does not store data recorded only in the second deformation data 4200 illustrated in FIG. 4B. Similarly, the second difference determination table 1110 illustrated in FIG. 11B stores difference determination results only for the section data recorded in the second deformation data 4200 illustrated in FIG. 4B, and does not store data recorded only in the first deformation data 4100 illustrated in FIG. 4A.

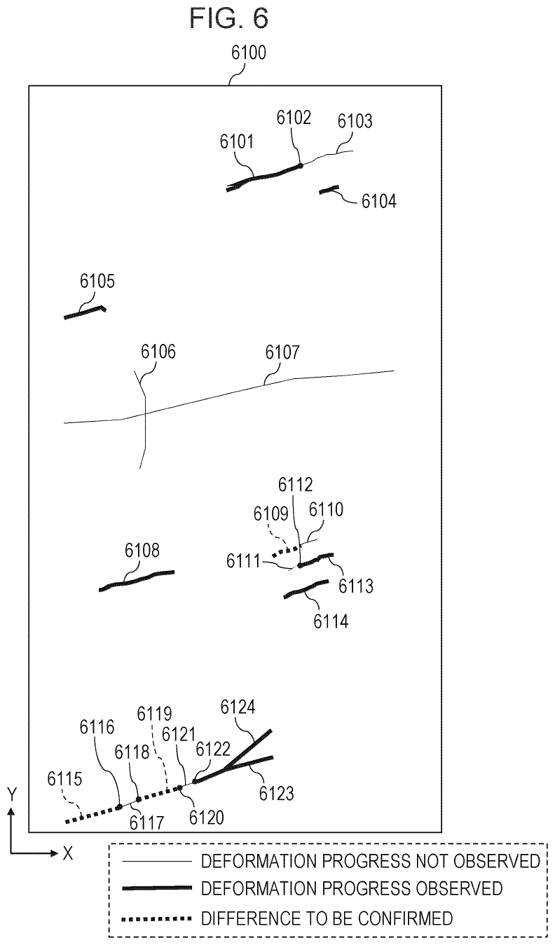

FIG. 6 is a diagram illustrating an example of a deformation diagram (6100) of third deformation data generated from the first difference determination data 5100 illustrated in FIG. 5A and the second difference determination data 5200 illustrated in FIG. 5B. In the deformation diagram (6100), the deformation classification legend is not as to the presence or absence of a difference but as to whether or not deformation progress has been observed. The deformation diagram (6100) of the third deformation data illustrated in FIG. 6 has legend classifications indicated in the dotted line box for the state of deformation progress of the first deformation data 201 and that of the second deformation data 202. In the deformation diagram (6100) illustrated in FIG. 6, the deformations determined to be “deformation progress not observed” are depicted using fine solid lines, and the deformations determined to be “deformation progress observed” are depicted using thick solid lines. In the deformation diagram (6100) illustrated in FIG. 6, deformations determined to be changing in the direction of improvement are determined to be “difference to be confirmed” and depicted using dotted lines so as to be differentiated from “deformation progress not observed” and “deformation progress observed”. In this case, a change in the direction of improvement means the disappearance of the deformation or a decrease in the width of the deformation. It is not usual for a deformation to spontaneously disappear or diminish in width once the deformation has occurred. Thus, the deformations determined to be “difference to be confirmed” make it possible for the user to determine, for each deformation, whether the restoration work is the correct result of the disappearance of the deformation or whether the deformation that was to be detected was missed due to poor AI deformation detection. Similarly to the display legend of the difference determination data, the depiction style, such as line type or line color, of the deformation legend in the deformation diagram (6100) may be changed to other display identifiable forms. The deformations that need special attention, such as “deformation progress observed” or “difference to be confirmed” may be displayed in an exaggerated manner.

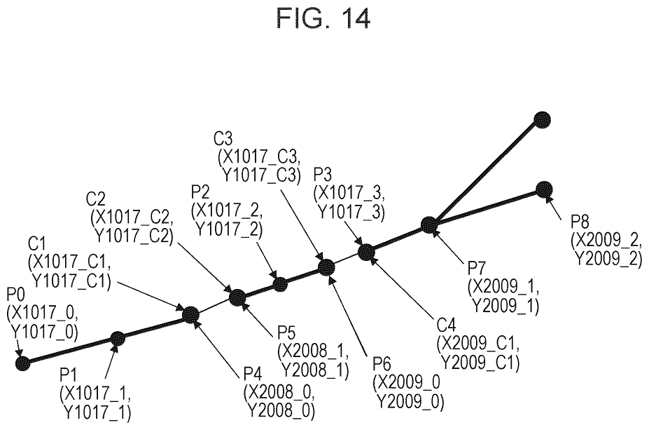

FIG. 14 is a diagram illustrating an example of a depiction obtained by enlarging combined deformation data indicated by signs 6115 to 6123 included in the deformation diagram (6100) illustrated in FIG. 6. Signs P0 to P8 and signs C1 to C4 in FIG. 14 correspond to the signs in FIGS. 13A and 13B. In FIG. 14, the signs P0 to P8 are vertices constituting the deformation data to be combined, and the signs C1 to C4 are vertices added to define partial matching sections in the difference determination data.

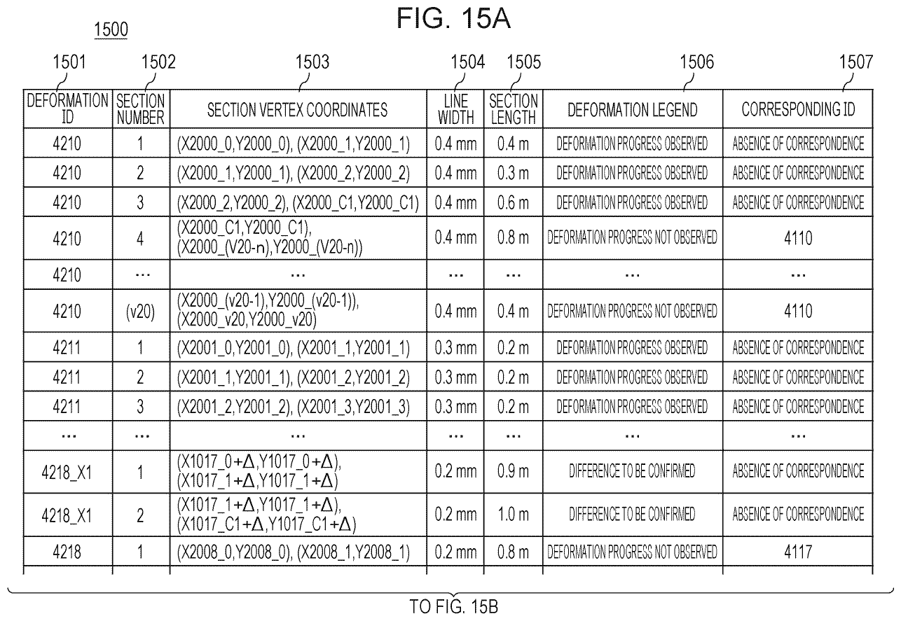

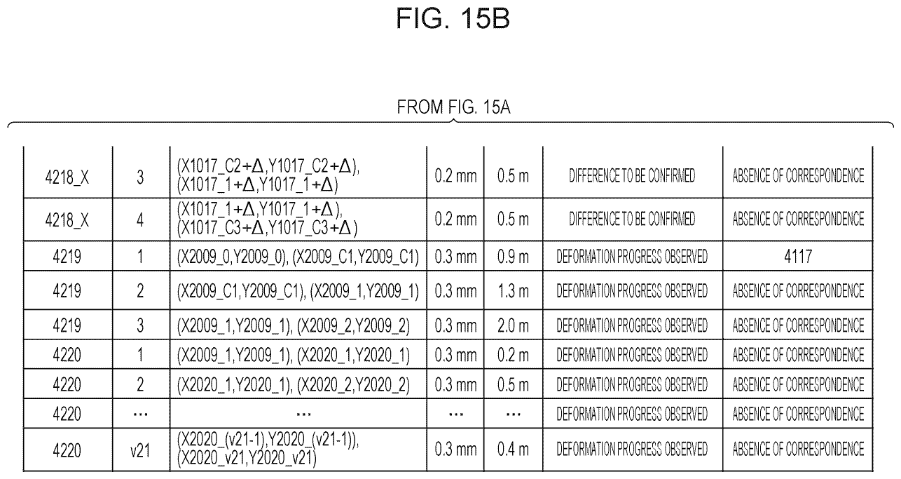

FIGS. 15A and 15B are diagrams illustrating an example of a deformation diagram data table 1500 that stores the data structure of the deformation diagram (6100) illustrated in FIG. 6. The deformation diagram data table 1500 stores deformation IDs 1501, section numbers 1502, section vertex coordinates 1503, line widths 1504, and section lengths 1505 corresponding to the deformation data illustrated in FIGS. 5A and 5B. Furthermore, the deformation diagram data table 1500 stores a deformation legend 1506 indicating determinations as to whether or not deformation progress has been observed, and corresponding IDs 1507 in the deformation data that are a comparison source. For example, the data with a deformation ID 1501 of 4210 and section numbers 1502 ranging from 1 to 3 each have “absence of correspondence” as its corresponding ID 1507 and “deformation progress observed” as the deformation legend 1506. Based on these, the data with a deformation ID 1501 of 4210 and section numbers 1502 ranging from 1 to 3 are not included in the deformation data that are the comparison source and correspond to a sign 6101 in FIG. 6 that denotes new deformation sections the occurrence of which has been recognized in the deformation data that are a comparison target. In contrast, the data with a deformation ID 1501 of 4210 and a section number 1502 of 4 has “4110” as its corresponding ID 1507. Based on this, the data with a deformation ID 1501 of 4210 and a section number 1502 of 4 corresponds to a sign 6103 in FIG. 6 that denotes the deformation section of “deformation progress not observed” that is included in and is not different from the deformation data that are the comparison source.

FIG. 18 is a flowchart illustrating an example of deformation diagram generating-editing processing included in the information processing method performed by the information processing apparatus 100 according to the embodiment of the present disclosure.

In the present embodiment, a first deformation image 211 of an object that is captured at a different time in the past, first deformation data 201 generated from the first deformation image 211, a second deformation image 212 of the object captured most recently, and second deformation data 202 generated from the second deformation image 212 are input to the input unit 210. The first deformation data 201 and the second deformation data 202 are data obtained from the first deformation image 211 and the second deformation image 212 by, for example, AI performing deformation detection, respectively. The difference determination unit 220 then identifies a common portion and a different portion between the first deformation data 201 obtained in the past and the second deformation data 202 obtained most recently, later than the time when the first deformation data 201 was obtained. The deformation diagram generation unit 230 then combines the common portions and the different portions of the first deformation data 201 and second deformation data 202 of the object identified by the difference determination unit 220 to generate and acquire a deformation diagram of third deformation data. Thereafter, the deformation diagram edit-operation unit 260 displays the deformation diagram of the third deformation data acquired by the deformation diagram generation unit 230, on the display output device 106, which is the display unit, via the display data generation unit 280 and edits the deformation diagram.

First, in Step S1801 of FIG. 18, the input unit 210 starts up a deformation diagram generation application that is not illustrated, and inputs, as processing target data, the first deformation data 201, the second deformation data 202, the first deformation image 211, and the second deformation image 212.

Next, in Step S1802 of FIG. 18, the difference determination unit 220 refers to the first deformation image 211 and the second deformation image 212 to perform difference determination processing for identifying a common portion and a different portion between the first deformation data 201 and the second deformation data 202. In this case, the difference determination unit 220 generates, for example, the first difference determination table 1100 and the second difference determination table 1110 in the work memory 103.

Next, in Step S1803 of FIG. 18, the deformation diagram generation unit 230 combines the common portions and the different portions of the first deformation data 201 and the second deformation data 202 of the object to generate and acquire a deformation diagram of third deformation data. In this case, the deformation diagram generation unit 230 generates, in the work memory 103, the deformation diagram data table 1500 obtained by referring to and combining the first difference determination table 1100 and the second difference determination table 1110 generated in the work memory 103, for example.

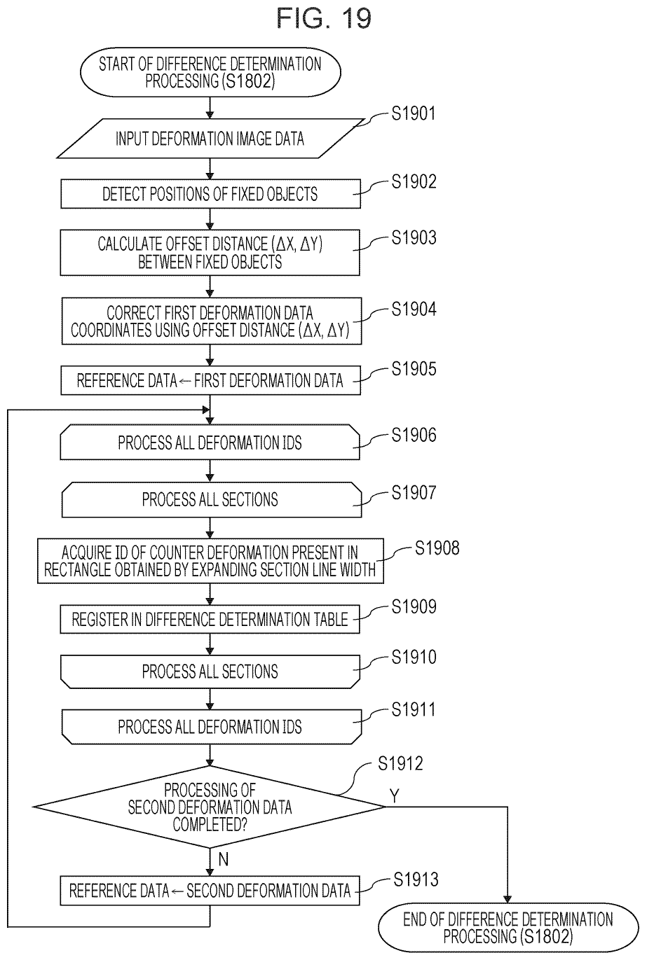

Next, in Step S1804 of FIG. 18, the deformation diagram edit-operation unit 260 displays, on the display output device 106 via the display data generation unit 280, a user interface through which editing can be operated, and the deformation diagram data table 1500 generated in the work memory 103. In this case, the deformation diagram edit-operation unit 260 may take the form of displaying a deformation diagram based on the deformation diagram data table 1500 on the display output device 106. Thereafter, the deformation diagram edit-operation unit 260 updates the deformation diagram data table 1500 in accordance with the user's confirmation, correction, and selection operation instructions. Moreover, in accordance with a save instruction from the user, the deformation diagram recording unit 270 saves the deformation diagram data table 1500 in the storage device 104. The deformation diagram edit-operation unit 260 ends, in accordance with an editing ending instruction from the user, processing in the flowchart regarding the deformation diagram generating-editing processing illustrated in FIG. 18. FIG. 19 is a flowchart illustrating an example of a detailed processing procedure of the difference determination processing in Step S1802 of FIG. 18.

First, in Step S1901 of FIG. 19, the difference determination unit 220 inputs, as deformation image data to be processed, the data of the first deformation image 211 and the data of the second deformation image 212 stored in the work memory 103.

Next, in Step S1902 of FIG. 19, for example, the fixed-common-portion detection unit 250 detects the positions of fixed common portions depicted in common in the data of the first deformation image 211 and the data of the second deformation image 212. In the present embodiment, as fixed objects serving as fixed common portions, rectangular objects other than deformation regions and recorded in deformation images are treated as detection targets as fixed object candidates. This is because rectangular features can be seen in, for example, lighting devices and road signs installed on the inner wall lining of the tunnel, which is the object. In this rectangle detection, the contour lines are extracted from the first deformation image 211 by performing the Hough transform or using a Sobel filter, and the line segment combinations that form rectangular regions are selected. Thereafter, a template matching search is performed on the second deformation image 212 using each selected rectangular region as a pattern, and the matching result whose position is closest to the rectangular region used as the pattern is determined to be a fixed object. A certain vertex of the rectangle on the first deformation image 211 and that on the second deformation image 212 are set as a first fixed point and a second fixed point, respectively. For example, rectangular regions 3101, 3102, and 3103 are detected as fixed objects from the first deformation image 3100 (211) illustrated in FIG. 3A, and the upper left vertex of the rectangular region 3103 is set as the first fixed point. Similarly, for example, rectangular regions 3201, 3202, and 3203 are detected as fixed objects from the second deformation image 3200 (212) illustrated in FIG. 3B. The upper left vertex of the rectangular region 3203, which can be estimated to be the fixed object co-located with the region 3103 of the fixed object, is then set as the second fixed point.

Next, in Step S1903 of FIG. 19, for example, the difference determination unit 220 calculates, as an offset value, the relative distance between the first fixed point and the second fixed point set in Step S1902. In this case, the offset value is obtained as the difference ΔX between the X coordinate values and the difference ΔY between the Y coordinate values.

Next, in Step S1904 of FIG. 19, for example, the difference determination unit 220 corrects the coordinate values in the first deformation data table 1000 illustrated in FIG. 10A by adding the offset value (ΔX, ΔY) calculated in Step S1903. As a result, even in a case where there is a displacement between the image capturing range of the first deformation image 211 and that of the second deformation image 212, the position coordinates on the inner wall lining of the tunnel, which is the object, will match.

In the difference determination processing performed by the difference determination unit 220, since the difference is obtained by fixing one of the two different data as reference data and treating the other data as variable data, which of the first deformation data 201 and the second deformation data 202 will be used as the reference data is determined.

Next, in Step S1905 of FIG. 19, the difference determination unit 220 sets, as the reference data for the difference determination processing, the first deformation data 201. When the first deformation data 201 is set, the first deformation data table 1000 illustrated in FIG. 10A is also set.

Next, in Step S1906 of FIG. 19, the difference determination unit 220 starts a loop for processing all deformation IDs 1001 recorded in the first deformation data table 1000 set in Step S1905.

Next, in Step S1907 of FIG. 19, the difference determination unit 220 starts a loop for processing the sections of all the section numbers 1002 in the deformation data having the same deformation ID 1001.

Next, in Step S1908 of FIG. 19, the difference determination unit 220 searches whether the section line segment indicated by the section vertex coordinates 1003 matches the second deformation data 202 on the counter data side, and acquires the deformation ID of the second deformation data having a matching section line segment. In this case, by performing the coordinate correction processing in Step S1904, the approximate coordinates of the deformation data recorded at the same position are supposed to match. However, due to recording errors caused by differences between deformation recording methods and detection errors that occur when AI detects deformations, an allowable range is set to determine whether or not the deformation data are recorded at the same position. In this case, the width of the allowable range is denoted by AW. By forming a rectangular section that is obtained by widening both sides of the section line segment of the first deformation data 201 by AW in the vertical direction and determining whether or not the section of the second deformation data 202 is present in this rectangular section, it is possible to determine co-locality with error tolerance.

In contrast, a case will be described in which not only images are misaligned due to differences in the image capturing range but also a single deformation image is generated by combining images captured separately. In this case, when the image capturing conditions (an image pickup device, the angle of view of the lens, and an image capturing distance to the inner wall lining) change between the time of capturing of the first deformation image 211 and that of the second deformation image 212, local misalignments may occur in the combined image.

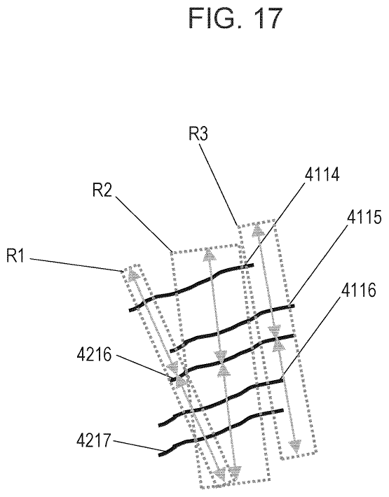

Thus, the allowable range AW in the search for the same deformation between two deformation data can be set larger as illustrated in FIG. 17 to be described below to improve the capture rate of the same deformation.

FIG. 17 is a diagram illustrating an example of arrangement of first deformations 4114, 4115, and 4116 recorded in the first deformation data 4100 illustrated in FIG. 4A and second deformations 4216 and 4217 recorded in the second deformation data 4200 illustrated in FIG. 4B in the same coordinate system. Dotted line frames R1, R2, and R3 illustrated in FIG. 17 are rectangular sections used during the search for a corresponding deformation with respect to the second deformation 4216, and the length of each arrow is AW. Since the first deformations 4114, 4115, and 4116 are also included in the rectangular dotted line frames R1, R2, and R3 indicating the corresponding allowable ranges of the second deformation 4216, it is determined that any of the first deformations 4114, 4115, and 4116 may correspond to the second deformation 4216.

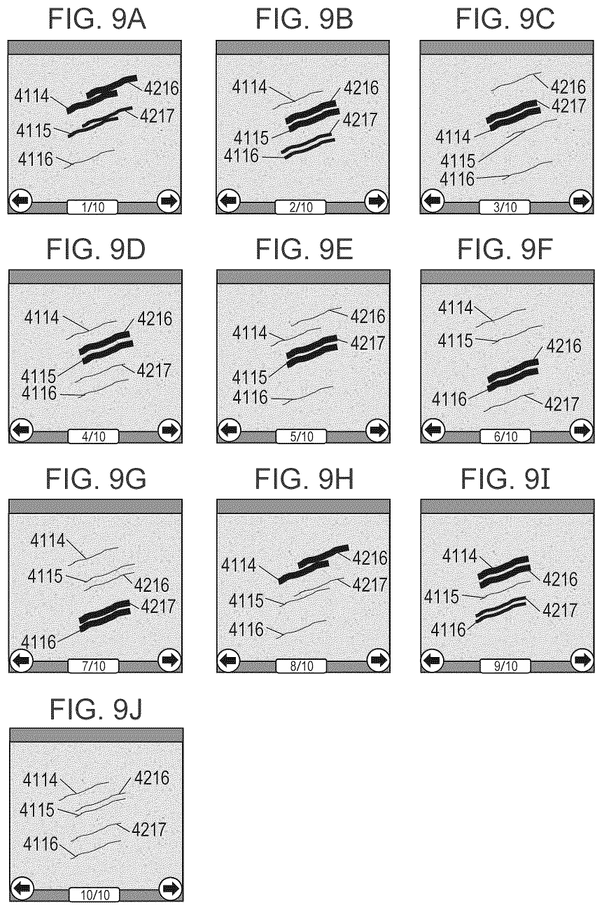

In such cases, possible combinations of candidates for the corresponding deformation are generated, and the corresponding deformation is determined in accordance with evaluation values obtained from the distance from the reference deformation and the values of the section length and section width of the deformation. The unselected combinations of candidates are stored in the same format as the difference determination table in the work memory 103. In the case of FIG. 17, for the combinations of candidates for the corresponding deformation stored in the work memory 103, there are 10 patterns illustrated in FIGS. 9A to 9J to be described below.

Now, returning again to the description of FIG. 19.

When the processing in Step S1908 of FIG. 19 ends, the process proceeds to Step S1909.

When the process proceeds to Step S1909 of FIG. 19, the difference determination unit 220 registers, as deformation correspondence data, the deformation ID of the second deformation data 202 determined to be at the same position in the corresponding ID 1107 of the first difference determination table 1100. The difference determination unit 220 transcribes the data of the first deformation data table 1000 illustrated in FIG. 10A, which is the reference, into the deformation ID 1101, the section number 1102, the section vertex coordinates 1103, the line width 1104, and the section length 1105 of the first difference determination table 1100 illustrated in FIG. 11A. The difference determination unit 220 then compares the line width 1014 of the matching section of the second deformation data 202 indicated by the corresponding ID with the line width 1004 of the first deformation data 201, which is the reference, and registers the change in width into the change in width 1106 of the first difference determination table 1100 illustrated in FIG. 11A. In the change in width 1106 in FIG. 11A, for example, “−” (minus) is registered when the result of subtracting the line width 1014 from the line width 1004 is negative, “0” when the result is “0”, and “+” (plus) when the result is positive. In a case where a comparison cannot be made because a corresponding ID is not obtained, “absence of correspondence” is recorded.

Next, in Step S1910 of FIG. 19, the difference determination unit 220 determines whether or not processing for all the sections corresponding to the same deformation ID has been completed. As a result of this determination, in a case where the processing for all the sections corresponding to the same deformation ID is incomplete, an unprocessed section is set, and the processing in and after Step S1907 will be performed.

In a case where it is determined in Step S1910 of FIG. 19 that the processing for all the sections corresponding to the same deformation ID has been completed, the process proceeds to Step S1911.

When the process proceeds to Step S1911 of FIG. 19, the difference determination unit 220 determines whether or not processing for all the deformation IDs has been completed. In a case where it is determined that the processing for all the deformation IDs is incomplete, an unprocessed deformation ID is set, and the processing in and after Step S1906 will be performed.

In a case where it is determined in Step S1911 of FIG. 19 that the processing for all the deformation IDs has been completed, the process proceeds to Step S1912.

When the process proceeds to Step S1912 of FIG. 19, the difference determination unit 220 determines whether or not processing of the second deformation data 202 has been completed.

In a case where it is determined in Step S1912 of FIG. 19 that the processing of the second deformation data 202 is incomplete (S1912/N), the process proceeds to Step S1913.

When the process proceeds to Step S1913 of FIG. 19, the difference determination unit 220 sets the reference data for the difference determination processing to the second deformation data 202. When the second deformation data 202 is set, the second deformation data table 1010 illustrated in FIG. 10B is also set. Thereafter, in Steps S1906 to S1911, processing will be performed in which the second deformation data 202 and the second deformation data table 1010 are applied instead of the first deformation data 201 and the first deformation data table 1000 described above, respectively.

In a case where it is determined in Step S1912 of FIG. 19 that the processing of the second deformation data 202 has been completed (S1912/Y), the first difference determination table 1100 for the first deformation data 201 is generated in the work memory 103. Similarly, the second difference determination table 1110 for the second deformation data 202 is generated in the work memory 103. Thereafter, the processing in the flowchart illustrated in FIG. 19 ends.

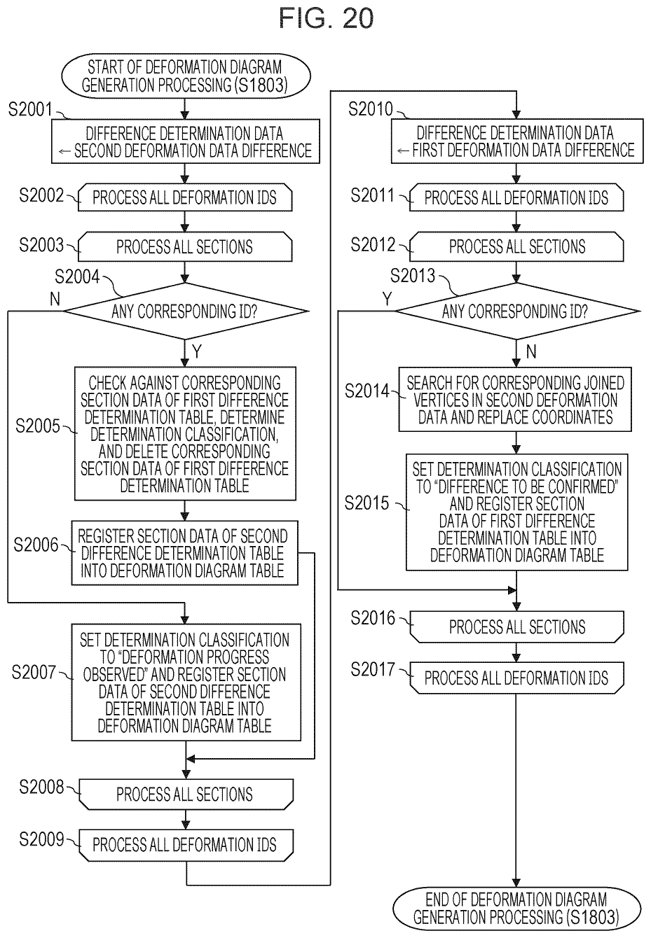

FIG. 20 is a flowchart illustrating an example of a detailed processing procedure of the deformation diagram generation processing in Step S1803 of FIG. 18.

First, in Step S2001 of FIG. 20, the deformation diagram generation unit 230 sets, as the difference determination data used as the reference for generating a deformation diagram, the second difference determination table 1110 for the second deformation data 202. This is because the deformation diagram generation processing in Step S1803 of FIG. 18 is performed to improve the accuracy of the deformation diagram of the second deformation data 202 detected from the second deformation image 212 that is the most recently captured image.

Next, in Step S2002 of FIG. 20, the deformation diagram generation unit 230 starts a loop for processing all the deformation IDs 1111 recorded in the second difference determination table 1110 set in Step S2001.

Next, in Step S2003 of FIG. 20, the deformation diagram generation unit 230 starts a loop for processing the sections of all the section numbers 1112 in the deformation data having the same deformation ID 1111.

Next, in Step S2004 of FIG. 20, the deformation diagram generation unit 230 determines whether or not the corresponding ID 1117 of the section being processed is present.

In a case where it is determined in Step S2004 of FIG. 20 that the corresponding ID 1117 of the section being processed is present (S2004/Y), that is, a deformation ID corresponding to the corresponding ID 1117 of the section being processed is registered, the process proceeds to Step S2005.

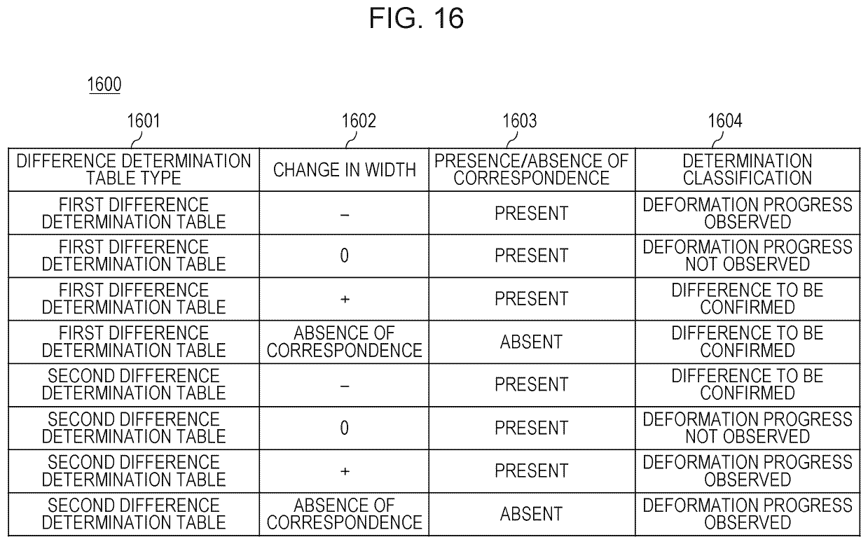

When the process proceeds to Step S2005 of FIG. 20, the deformation diagram generation unit 230 searches for and checks against the corresponding section data of the corresponding first deformation ID and acquires the value of the change in width 1106. FIG. 16 is a diagram illustrating an embodiment of the present disclosure and is a diagram illustrating an example of a legend table 1600. The legend table 1600 illustrated in FIG. 16 stores difference determination table types 1601, changes in width 1602, presences/absences of correspondences 1603, and determination classifications 1604. Regarding the first difference determination table 1100, the deformation diagram generation unit 230 checks, under the condition where the corresponding ID is present, the value of the change in width 1106 against the legend table 1600 illustrated in FIG. 16 to determine the determination classification 1604 of the legend table 1600 illustrated in FIG. 16. For example, when the value of the change in width 1106 is “0”, the determination classification 1604 is determined to be “deformation progress not observed”. The deformation diagram generation unit 230 deletes the data of the corresponding section of the first difference determination table 1100 for which the determination classification 1604 is determined so as not to be referenced again.

Next, in Step S2006 of FIG. 20, the deformation diagram generation unit 230 registers the section data being processed of the second difference determination table 1110 into the deformation diagram data table 1500 illustrated in FIGS. 15A and 15B.

In a case where it is determined in Step S2004 of FIG. 20 that the corresponding ID 1117 of the section being processed is absent (S2004/N), that is, the corresponding ID 1117 of the section being processed is “absence of correspondence”, the process proceeds to Step S2007.

When the process proceeds to Step S2007 of FIG. 20, the deformation diagram generation unit 230 interprets the section as a new deformation that has occurred and that is not present in the first deformation data 201, and determines the determination classification 1604 of the legend table 1600 illustrated in FIG. 16 to be “deformation progress observed”. The deformation diagram generation unit 230 then registers, as “deformation progress observed”, the section data into the deformation diagram data table 1500 illustrated in FIGS. 15A and 15B.

In a case where the processing in Step S2006 of FIG. 20 has been completed or a case where the processing in Step S2007 of FIG. 20 has been completed, the process proceeds to Step S2008.

When the process proceeds to Step S2008 of FIG. 20, the deformation diagram generation unit 230 determines whether or not the processing for all the sections corresponding to the same deformation ID has been completed. As a result of this determination, in a case where the processing for all the sections corresponding to the same deformation ID is incomplete, an unprocessed section is set, and the processing in and after Step S2003 will be performed.

Moreover, in a case where it is determined in Step S2008 of FIG. 20 that the processing for all the sections corresponding to the same deformation ID has been completed, the process proceeds to Step S2009.

When the process proceeds to Step S2009 of FIG. 20, the deformation diagram generation unit 230 determines whether or not processing for all the deformation IDs has been completed. In a case where it is determined that the processing for all the deformation IDs is incomplete, an unprocessed deformation ID is set, and the processing in and after Step S2002 will be performed.

In a case where it is determined in Step S2009 of FIG. 20 that the processing for all the deformation IDs has been completed, the process proceeds to Step S2010.

When the process proceeds to Step S2010 of FIG. 20, the deformation diagram generation unit 230 sets, as the difference determination data used as the reference for generating a deformation diagram, the first difference determination table 1100 for the first deformation data 201. This is performed to verify whether or not to add the first deformation data 201 that is not detected in the second deformation data 202.

Next, in Step S2011 of FIG. 20, the deformation diagram generation unit 230 starts a loop for processing all the deformation IDs 1101 recorded in the first difference determination table 1100 set in Step S2010.

Next, in Step S2012 of FIG. 20, the deformation diagram generation unit 230 starts a loop for processing the sections of all the section numbers 1102 in the deformation data having the same deformation ID 1101.

Next, in Step S2013 of FIG. 20, the deformation diagram generation unit 230 determines whether or not the corresponding ID 1107 of the section being processed is present.

In a case where it is determined in Step S2013 of FIG. 20 that the corresponding ID 1107 of the section being processed is absent (S2013/N), that is, a deformation ID corresponding to the corresponding ID 1107 of the section being processed is “absence of correspondence”, the process proceeds to Step S2014.

When the process proceeds to Step S2014 of FIG. 20, the deformation diagram generation unit 230 searches for and checks against the corresponding section data of the corresponding second deformation ID and acquires the values of the corresponding joint vertices. In the example of the difference determination data illustrated in FIG. 13A and having a deformation ID of “4117”, when the deformation ID 1101 is 4117 and the section number 1102 is 3 in the first difference determination table 1100 illustrated in FIG. 11A, the corresponding ID 1107 is “4218”. When the second difference determination table 1110 illustrated in FIG. 11B is searched for data whose deformation ID 1111 is “4218”, difference determination data is obtained whose deformation ID 1111 is 4218, whose section number 1112 is 1, and whose corresponding ID 1117 is “4117”. The section vertex coordinates 1113, (X2008_0, Y2008_0) and (X2008_1, Y2008_1), in the second difference determination table 1110 are vertices P4 and P5 illustrated in FIG. 13B. Thus, the deformation diagram generation unit 230 replaces the coordinate values of the vertex C1 (X1017_C1, Y1017_C1) and those of the vertex C2 (X1017_C2, Y1017_C2) illustrated in FIG. 13A with the coordinate values of the vertex P4 and those of the vertex P5 illustrated in FIG. 13B, respectively. Moreover, the deformation diagram generation unit 230 corrects the other section vertices P0, P1, P2, C3, and P3 of the same deformation ID “4117” by adding the differences (C1-P4) and (C2-P5).

Next, in Step S2015 of FIG. 20, the deformation diagram generation unit 230 refers to the legend table 1600 illustrated in FIG. 16 and determines the determination classification 1604 to be “difference to be confirmed” since “absence of correspondence” is obtained for the first difference determination table 1100. The deformation diagram generation unit 230 then registers, as “difference to be confirmed”, the section data into the deformation diagram data table 1500 illustrated in FIGS. 15A and 15B.

In a case where the processing in Step S2015 of FIG. 20 has been completed or a case where it is determined in Step S2013 of FIG. 20 that the corresponding ID 1107 of the section being processed is present (S2013/Y), the process proceeds to Step S2016.

When the process proceeds to Step S2016 of FIG. 20, the deformation diagram generation unit 230 determines whether or not processing for all the sections corresponding to the same deformation ID has been completed. As a result of this determination, in a case where the processing for all the sections corresponding to the same deformation ID is incomplete, an unprocessed section is set, and the processing in and after Step S2012 will be performed.

In a case where it is determined in Step S2016 of FIG. 20 that the processing for all the sections corresponding to the same deformation ID has been completed, the process proceeds to Step S2017.

When the process proceeds to Step S2017 of FIG. 20, the deformation diagram generation unit 230 determines whether or not processing for all the deformation IDs has been completed. As a result of this determination, in a case where it is determined that the processing for all the deformation IDs is incomplete, an unprocessed deformation ID is set, and the processing in and after Step S2011 will be performed.

In a case where it is determined in Step S2017 of FIG. 20 that the processing for all the deformation IDs has been completed, the deformation diagram (6100) illustrated in FIG. 6 is generated, in the work memory 103, as the deformation diagram data table 1500 illustrated in FIGS. 15A and 15B. Thereafter, the processing in the flowchart illustrated in FIG. 20 ends.

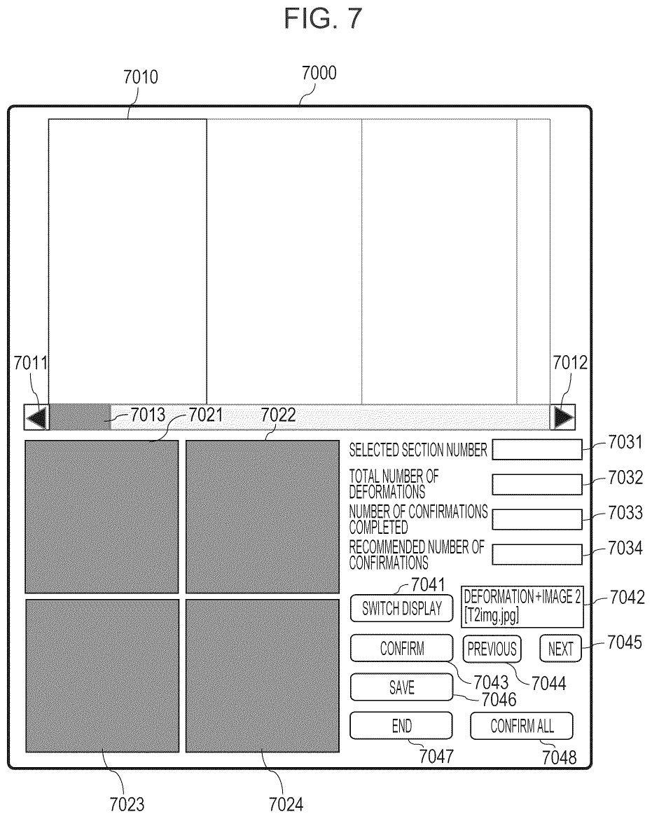

Once a deformation diagram of the third deformation data is generated by the deformation diagram generation unit 230, the user can perform confirmation-correction processing (changing processing) on this deformation diagram. When the application for confirming and correcting the deformation diagram is started by an application startup unit that is not illustrated, the deformation diagram confirmation-correction processing in step S1804 of FIG. 18 described above will be performed. The processing in Step S1804 of FIG. 18 will be described using application execution screens illustrated in FIGS. 7 to 9J.

FIG. 7 is a diagram illustrating an example of a deformation diagram confirmation-correction operation display screen 7000 displayed on the display output device 106 illustrated in FIG. 1. On the deformation diagram confirmation-correction operation display screen 7000 illustrated in FIG. 7, a deformation diagram and a deformation image are displayed in a display region 7010. The deformation diagram and the deformation image are divided by span, which is the unit of lining, and are displayed in the display region 7010, and the display range can be specified by operating a slider 7013 or a backward button 7011 and a forward button 7012.

On the deformation diagram confirmation-correction operation display screen 7000 illustrated in FIG. 7, a deformation diagram to be confirmed (third deformation data) is displayed in an enlarged manner in a display region 7021. In a display region 7023, only the first deformation image 211, which includes the first deformation data 201, is displayed in an enlarged manner. In a display region 7024, only the second deformation image 212, which includes the second deformation data 202, is displayed in an enlarged manner. Moreover, in a display region 7022, the image obtained by superimposing the first deformation data 201 and the second deformation data 202 is displayed in an enlarged manner. Moreover, a selected section number display unit 7031, a total-number-of-deformations display unit 7032, a number-of-confirmations-completed display unit 7033, and a recommended-number-of-confirmations display unit 7034 are provided to the right of the display region 7022. Each time a Switch Display button 7041 is operated by the user, the deformation image to be superimposed and displayed on the display region 7010 is switched in the order of the first deformation image 211, the second deformation image 212, and no image display. A display region 7042 displays the current switching state controlled by the Switch Display button 7041. A Confirm button 7043 is operated by the user to set the state of the confirmation-correction target deformation. A Previous button 7044 is operated by the user to display the immediately preceding confirmation-correction target deformation. A Next button 7045 is operated by the user to display the next confirmation-correction target deformation. A Save button 7046 is operated by the user to save the deformation diagram in the storage device 104. An End button 7047 is operated by the user to end the entire deformation diagram confirmation-correction processing. A Confirm All button 7048 is operated by the user to confirm and set all of the deformations that are targets for which confirmation is recommended.

When the user operates the Confirm button 7043 on the deformation diagram confirmation-correction operation display screen 7000 illustrated in FIG. 7, the deformation diagram data table 1500 generated in the work memory 103 is loaded into the application, and the deformation diagram confirmation-correction processing is started.

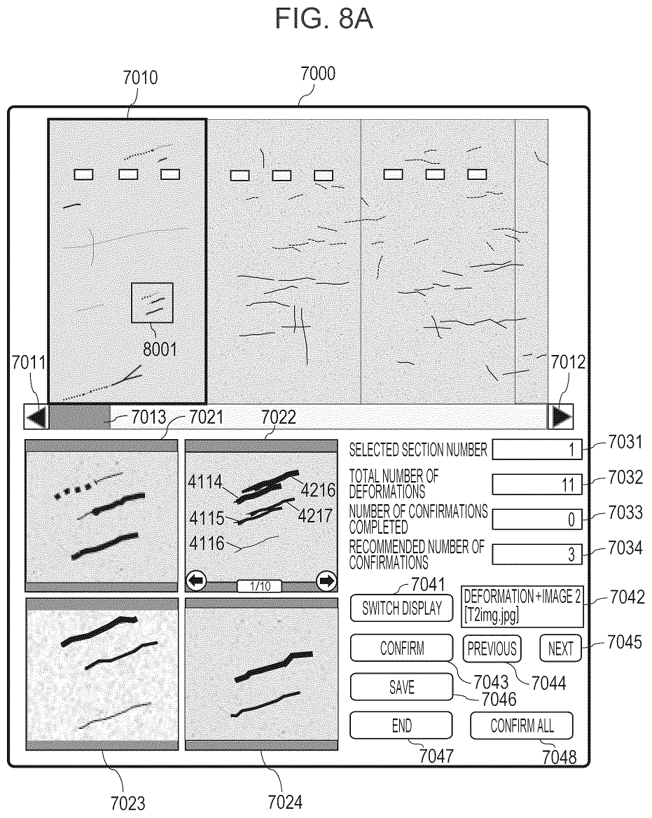

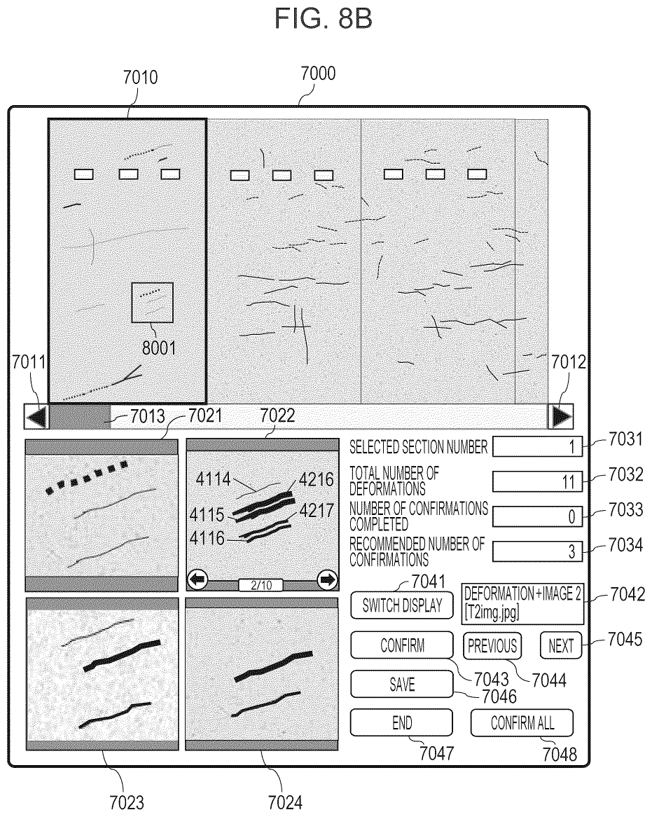

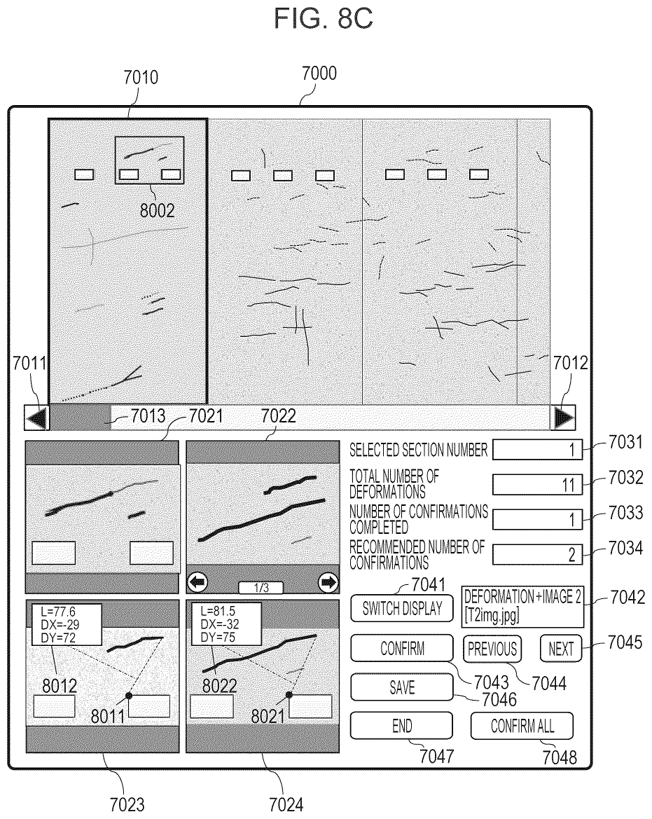

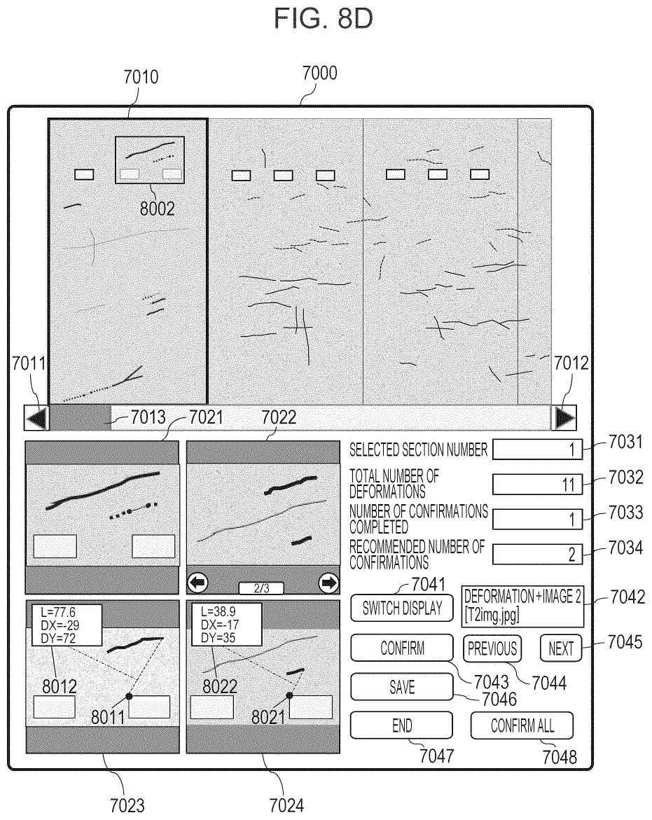

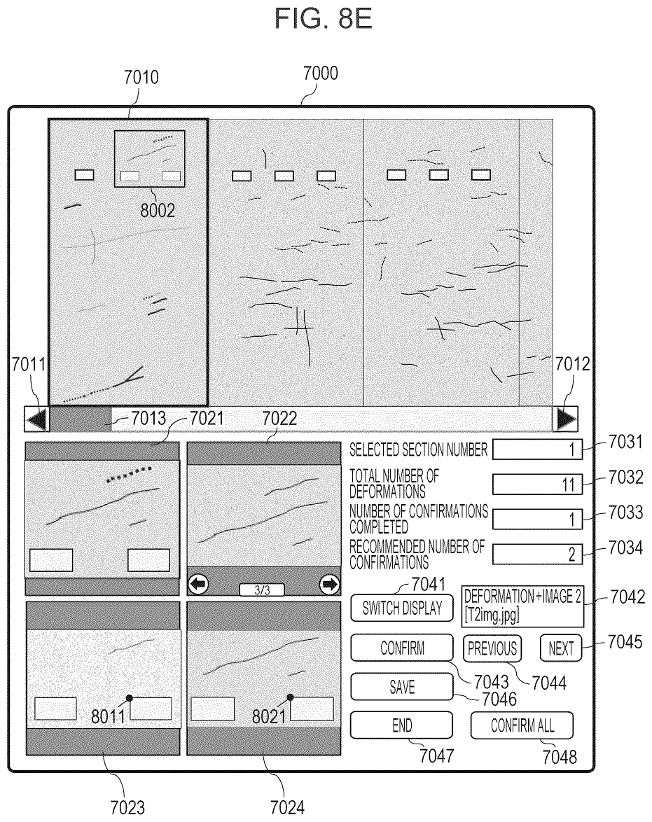

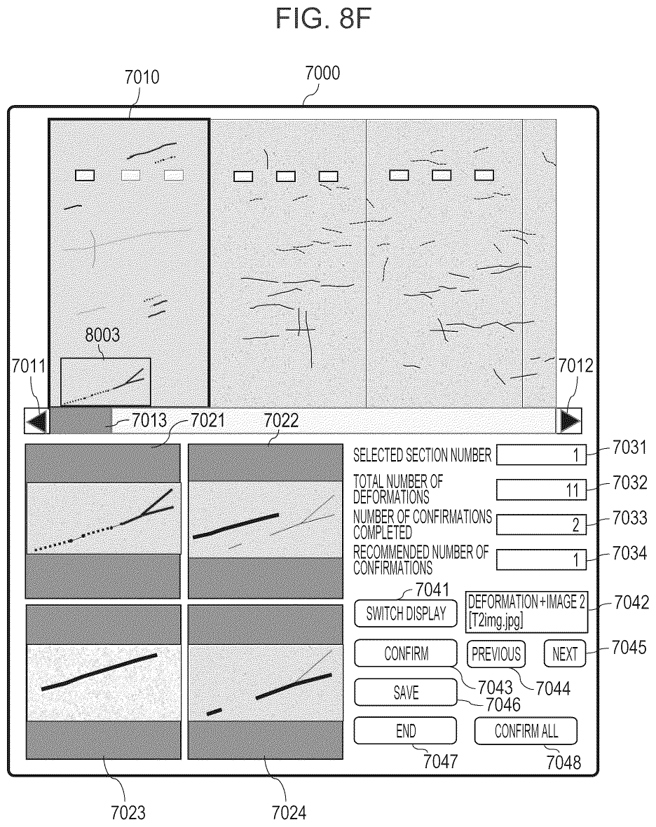

FIG. 8A is a diagram illustrating a first display example of the deformation diagram confirmation-correction operation display screen 7000 displayed on the display output device 106 illustrated in FIG. 1. In FIG. 8A, the same constructional elements as those illustrated in FIG. 7 will be denoted by the same signs, and detailed description thereof will be omitted. In FIG. 7, when the user operates the Confirm button 7043, the deformation diagram based on the deformation diagram data table 1500 loaded into the application is displayed in the display region 7010. In the present embodiment, superimposed display with the second deformation image 212 is specified as a default value for display switching, and thus the deformation diagram (third deformation data) based on the deformation diagram data table 1500 is superimposed on the second deformation image 212 and is displayed in the display region 7010. Moreover, part of the deformation diagram that is a target for which confirmation is recommended is displayed in the display region 7021. A rectangular frame 8001 in the range of the display region 7010 in FIG. 8A indicates a region corresponding to the display region 7021. Suppose that the rectangular frame 8001 is a region obtained by adding a predetermined width to the top, bottom, left, and right of the bounding region of the combinations of deformation data having deformation correspondences illustrated in FIG. 17. Note that the rectangular frame 8001 may be the bounding region of a single combination of deformation data having a single deformation correspondence, instead of being the bounding region of the multiple combinations of deformation data having multiple deformation correspondences.

The deformation data of the deformation diagram that is a target for which confirmation is recommended will be part of the deformation diagram where other configuration patterns may be selected, in addition to the partial pattern of the deformation diagram determined in the deformation diagram generation processing. Other configuration patterns that were not selected when a determination was made in the deformation diagram generation processing are retained as other candidate tables in the work memory 103. “3” displayed in the recommended-number-of-confirmations display unit 7034 will be the total number of deformation diagram parts that are targets for which confirmation is recommended.

In FIG. 8A, the display region 7022 displays deformation parts that are targets for which confirmation is recommended and where the first deformation data 201 and the second deformation data 202 are superimposed with each other such that corresponding deformation pairs are located at the same positions. Note that if the deformation parts are completely superposed with each other at the same position, it becomes difficult to confirm the deformation correspondence. Thus, the display region 7022 displays the deformation parts at positions that are shifted by a width similar to those of the displayed lines. In the display of the deformation lines in the display region 7022, the deformation pair of the same line width is considered to occur at the same position, which is the deformation correspondence. In the display region 7022, in order to facilitate distinction of the deformation data, the deformation IDs identifying the deformation data are displayed as pull-out line displays “4114”, “4115”, “4116”, “4216”, and “4217”. In this case, if the deformation ID of the first deformation data 201 is displayed on one side of the deformation data and the deformation ID of the second deformation data 202 is displayed on the other side of the deformation data, it is easier to distinguish the first deformation data 201 and the second deformation data 202 from each other. In the example of deformation correspondence candidates “1/10” displayed in the display region 7022 in FIG. 8A, the deformation IDs “4114” and “4216”, which are depicted with the same line width, have a deformation correspondence between them. Similarly, in the example of the deformation correspondence candidates “1/10” displayed in the display region 7022 in FIG. 8A, the deformation IDs “4115” and “4217”, which are depicted with the same line width, have a deformation correspondence between them. Note that the deformation IDs can be erased by entering a specific key entry sequence, which is not illustrated, or by using other methods. FIGS. 8C to 8F, to be described below, are examples of the display in which the deformation IDs are erased. The result of combining deformation diagrams considered to be the same deformation is the deformation diagram displayed in the display region 7021. The display region 7022 in FIG. 8A displays deformation pairs of three different thicknesses. The “1/10” displayed in the lower center of the display region 7022 indicates that there are a total of 10 combination patterns of candidates for the corresponding first and second deformation data 201 and 202 and that the first one out of the 10 combination patterns is displayed. The right and left arrows displayed in the display region 7022 are operation icons, and the “previous” or “next” deformation correspondence combination is displayed in the display region 7022 by operating these operation icons.

In the display region 7023 in FIG. 8A, only the first deformation data 201 of the deformation diagram portion displayed in the display region 7021 and the first deformation image 211 are superimposed and displayed. In the display region 7024 in FIG. 8A, only the second deformation data 202 of the deformation diagram portion displayed in the display region 7021 and the second deformation image 212 are superimposed and displayed. For example, in the display region 7024, the deformations are depicted using the same line widths as those of the deformations displayed in the display region 7023, which makes it possible to determine the deformation correspondence between the deformation data in the display region 7023 and that in the display region 7024.

Operating the right arrow in the display region 7022 in FIG. 8A will display another deformation correspondence combination of the first deformation data 201 and the second deformation data 202 and transition to the display screen illustrated in FIG. 8B.

FIG. 8B is a diagram illustrating a second display example of the deformation diagram confirmation-correction operation display screen 7000 displayed on the display output device 106 illustrated in FIG. 1. In FIG. 8B, the same constructional elements as those illustrated in FIGS. 7 and 8A will be denoted by the same signs, and detailed description thereof will be omitted. The display region 7022 in FIG. 8B displays a deformation correspondence combination “2/10” of the deformation diagram portion indicated by the rectangular frame 8001 and different from that in FIG. 8A. Two sets of deformation correspondences remain the same, but the deformation correspondences distinguished by the thicknesses of the depicted lines in the display region 7022 in FIG. 8B are different from those for the “1/10” pattern in FIG. 8A. The display region 7021 in FIG. 8B displays the result of performing a difference determination again on the basis of the candidate pattern “2/10” and updating the deformation diagram.

FIGS. 9A to 9J are diagrams illustrating examples of deformation correspondence candidate patterns that may be displayed in the display region 7022 of the deformation diagram confirmation-correction operation display screen 7000 displayed on the display output device 106 illustrated in FIG. 1. In FIG. 8B, similarly to as in the case described using FIG. 8A, the deformation correspondence candidate patterns illustrated in FIGS. 9A to 9I are displayed in the display region 7022 by the user operating the right or left arrow operation icon displayed in the display region 7022. Thus, the user can specify, by operating the Confirm button 7043 serving as a deformation correspondence specification unit, whether the deformation correspondence “1/10” illustrated in FIG. 9A, which is displayed first, is correct or whether another deformation correspondence illustrated in FIGS. 9B to 9I is correct. In FIG. 9J, since the line widths are all the same, there is not a single deformation that can be considered identical to another, and all five deformation data are considered to correspond to different deformations from each other. In a case where there is not a desired pattern in the displayed candidate patterns, the user may directly specify deformation data in the display region 7022 using a pointing device such as a mouse. The candidate patterns illustrated in FIGS. 9A to 9J are arranged in order of increasing certainty of correspondence between the deformations. The certainty of correspondence between the deformations is determined using the reliability value obtained on the basis of, for example, the vertical distance between the deformations, the length of the section with a corresponding deformation pair, the similarity of direction in the section with a corresponding deformation pair, and the distances from the fixed point commonly depicted in both the first and second deformation images.

After displaying and examining other candidate patterns, when the user can confirm that the first deformation correspondence candidate, FIG. 9A, is the most appropriate, the user returns to the screen illustrated in FIG. 8A and operates the Confirm button 7043. Then, the deformation diagram edit-operation unit 260 confirms that the candidate pattern “1/10” selected in the display region 7022 indicates a correct deformation correspondence combination, updates the data of the deformation diagram portion on the basis of the confirmed deformation correspondence, and gives a confirmation. That is, the deformation diagram edit-operation unit 260 constitutes a “change unit” that changes the deformation diagram (third deformation data) displayed in the display region 7021 or the like on the basis of instructions to change the deformation correspondence between the first deformation data 201 and the second deformation data 202, which are displayed in in the display region 7022. When the user operates the Next button 7045 for displaying the next target for which confirmation is recommended, the screen transitions to the display screen illustrated in FIG. 8C, and the second deformation target for which confirmation is recommended is displayed.

FIG. 8C is a diagram illustrating a third display example of the deformation diagram confirmation-correction operation display screen 7000 displayed on the display output device 106 illustrated in FIG. 1. In FIG. 8C, the same constructional elements as those illustrated in FIGS. 7 and 8A to 8B will be denoted by the same signs, and detailed description thereof will be omitted. The display region 7021 in FIG. 8C displays part of the deformation diagram that is the second target for which confirmation is recommended. A rectangular frame 8002 in the range of the display region 7010 in FIG. 8C indicates a region corresponding to the display region 7021. In the display region 7022 in FIG. 8C, similarly to as in FIG. 8A, overlapping deformation portions based on the first deformation data 201 and the second deformation data 202 are displayed. In the present embodiment, since a confirmation operation is performed in FIG. 8B, the numerical value in the number-of-confirmations-completed display unit 7033 is “1”, and that in the recommended-number-of-confirmations display unit 7034 is “2”.

In the display region 7023 in FIG. 8C, only the first deformation data 201 of the deformation diagram portion displayed in the display region 7021 and the first deformation image 211 are superimposed and displayed. In the display region 7024 in FIG. 8C, only the second deformation data 202 of the deformation diagram portion displayed in the display region 7021 and the second deformation image 212 are superimposed and displayed.

Regarding the deformations displayed in the display region 7021 in FIG. 8C, fixed points of the fixed common portions (for example, the fixed common portions indicated by the rectangular regions 3101 to 3103 in FIG. 3A) detected by the fixed-common-portion detection unit 250 are present in the vicinity of the deformations. Thus, for the display region 7023 and the display region 7024 in FIG. 8C, display regions are cropped to include a fixed point 8011 and a fixed point 8021, respectively, and the fixed objects that are the fixed common portions. That is, the fixed common portions detected by the fixed-common-portion detection unit 250 (including the fixed common portion having the fixed point 8011) and the first deformation data 201 are superimposed and displayed in the display region 7023 in FIG. 8C. The fixed common portions detected by the fixed-common-portion detection unit 250 (including the fixed common portion having the fixed point 8021) and the second deformation data 202 are superimposed and displayed in the display region 7024 in FIG. 8C. By confirming the distances from the fixed points described above, it is easier for the user to grasp that the positions of the first and second deformation data 201 and 202, which form the deformation diagram, are identical. In the display region 7023 in FIG. 8C, three values of L as the straight-line distance from the fixed point 8011 of the first deformation data 201, DX as the distance in the X direction, and DY as the distance in the Y direction are displayed as information 8012 indicating an offset distance. Similarly, in the display region 7024 in FIG. 8C, three values of L as the straight-line distance from the fixed point 8021 of the second deformation data 202, DX as the distance in the X direction, and DY as the distance in the Y direction are displayed as information 8022 indicating an offset distance. In this case, the offset distances may be calculated on the basis of the coordinate values of the deformation image data or the actual dimensions of the structure (the object) into which the coordinate values are converted.

In the example illustrated in FIG. 8C, since “1/3” is displayed in the display region 7022, it is clear that there are other deformation correspondence combination candidates. The user can display other deformation correspondence combination candidates in the display region 7022 by operating the left arrow operation icon or right arrow operation icon displayed in the display region 7022.

FIG. 8D is a diagram illustrating a fourth display example of the deformation diagram confirmation-correction operation display screen 7000 displayed on the display output device 106 illustrated in FIG. 1. In FIG. 8D, the same constructional elements as those illustrated in FIGS. 7 and 8A to 8C will be denoted by the same signs, and detailed description thereof will be omitted. Specifically, FIG. 8D displays the second deformation correspondence combination candidate for the deformation region of the rectangular frame 8002 in the range of the display region 7010. In the deformation overlapping display in the display region 7022 in FIG. 8D, it appears that the deformation correspondence combination “2/3” is also possible. However, when the offset distance from the fixed point is compared with that in FIG. 8C, it is clear that the straight-line distance and the distances in the X and Y directions are all significantly different from those of the offset distance in FIG. 8C.

FIG. 8E is a diagram illustrating a fifth display example of the deformation diagram confirmation-correction operation display screen 7000 displayed on the display output device 106 illustrated in FIG. 1. In FIG. 8E, the same constructional elements as those illustrated in FIGS. 7 and 8A to 8D will be denoted by the same signs, and detailed description thereof will be omitted. Specifically, FIG. 8E displays the third deformation correspondence combination candidate for the deformation region of the rectangular frame 8002 in the range of the display region 7010. There is not a corresponding deformation correspondence for the deformation correspondence combination “3/3” in the display region 7022 in FIG. 8E. Thus, the display region 7021 in FIG. 8E displays a deformation diagram in which one deformation based on the first deformation data 201 and two deformations based on the second deformation data 202 are different deformations from each other. In a case where there is not a corresponding deformation correspondence between the deformations, information indicating an offset distance is not displayed in the display region 7023 or 7024 because the target to be compared is not identified. In a case where checking of an offset distance is desired, it is sufficient that the deformation correspondence combination “1/3” or “2/3” be simply displayed.

When the offset distance information 8012 and the offset distance information 8022 in FIG. 8C are compared with each other, the numerical values are not exactly the same. However, the numerical values are almost equivalent to each other and can be considered to be in the error range of the detection position. The degree of overlapping of the deformation correspondence in the display region 7022 in FIG. 8C does not also seem suspicious, and thus the deformation diagram based on the deformation correspondence combination “1/3” can be confirmed.

FIG. 8F is a diagram illustrating a sixth display example of the deformation diagram confirmation-correction operation display screen 7000 displayed on the display output device 106 illustrated in FIG. 1. In FIG. 8F, the same constructional elements as those illustrated in FIGS. 7 and 8A to 8E will be denoted by the same signs, and detailed description thereof will be omitted. Specifically, the display region 7021 in FIG. 8F displays part of the deformation diagram of the third target for which confirmation is recommended. A rectangular frame 8003 in the range of the display region 7010 in FIG. 8F indicates a region corresponding to the display region 7021. In the display region 7022 in FIG. 8F, similarly to as in FIG. 8A, overlapping deformation portions based on the first deformation data 201 and the second deformation data 202 are displayed. In the present embodiment, since a confirmation operation is performed in FIG. 8C, the numerical value in the number-of-confirmations-completed display unit 7033 is “2”, and that in the recommended-number-of-confirmations display unit 7034 is “1”.

In FIG. 8F, the display region 7022 does not display the operation icons for other deformation correspondence combination candidates. This is because there is only one deformation correspondence combination for the first deformation data 201 and the second deformation data 202, which are the source of the deformation diagram displayed in the display region 7021.

Once the user finishes checking the third deformation portion illustrated in FIG. 8F and for which confirmation is recommended, the user has finished checking all the targets for which confirmation is recommended. Thus, the deformation diagram is saved in the storage device 104 when the user operates the Save button 7046. When the user operates the End button 7047, the entire deformation diagram confirmation-correction processing ends, and the application ends.

In the above-described deformation diagram confirmation-correction process, the target deformation portions for which confirmation is recommended were confirmed one by one, but all the target deformation portions currently determined on the basis of the first prioritized deformation correspondence combination candidate may be confirmed by operating the Confirm All button 7048. If the accuracy of the deformation diagram generation is confirmed to be sufficiently high and no suspicious areas are found after overviewing the deformation diagram, the user can skip the confirmation and semi-automatically generate a deformation diagram.

The display output device 106 that displays the deformation diagram confirmation-correction operation display screen 7000 illustrated in FIGS. 8A to 8F constitutes a “display unit” that displays the deformation diagram of the third deformation data and the deformation correspondence between the first deformation data 201 and the second deformation data 202. Specifically, the display output device 106 displays the deformation diagram of the third deformation data in the display region 7021, and displays the deformation correspondence between the first deformation data 201 and the second deformation data 202 in the display region 7022. When the right or left arrow displayed in the display region 7022 is operated, the display output device 106 displays, in the display region 7022, multiple deformation correspondence candidates for the deformation correspondence between the first deformation data 201 and the second deformation data 202. The display output device 106 that displays the deformation diagram confirmation-correction operation display screen 7000 illustrated in, for example, FIG. 8C displays, in the display region 7023, the fixed common portions (including the fixed common portion having the fixed point 8011) detected by the fixed-common-portion detection unit 250 and the first deformation data 201 in a superimposed manner. Moreover, the display output device 106 that displays the deformation diagram confirmation-correction operation display screen 7000 illustrated in, for example, FIG. 8C displays, in the display region 7024, the fixed common portions (including the fixed common portion having the fixed point 8021) detected by the fixed-common-portion detection unit 250 and the second deformation data 202 in a superimposed manner.

In the present embodiment, the example has been described in which the fixed objects that are the fixed common portions used as a reference for positional identification are rectangular regions; however, the present embodiment is not limited to this example. For example, the position where a particular character string commonly appears, an elliptical region, or a region identifiable by color may be detected, or a pattern of fixed objects may be specified and registered in advance to make it possible to detect and search for registered objects. A graphics processing unit (GPU) can also be added to the information processing apparatus 100 illustrated in FIG. 1, and the graphics library can use the GPU to speed up image processing.

Note that the present embodiment has been described as an embodiment in which it is expected that the first deformation data 201 and the second deformation data 202 are taken, recorded, and detected at different times for the object. This is because the first deformation data 201 has already been confirmed and thus the certainty of the data is considered to be high compared with the uncertainty of the second deformation data 202. However, in the present disclosure, the first and second deformation data 201 and 202 are not limited to confirming the determination of differences between the data acquired over time. In the present disclosure, the first deformation data 201 and the second deformation data 202 can also be applied to confirm the determination of differences between two different deformation data of the same period. In this case, the two different deformation data, the first deformation data 201 and the second deformation data 202, could be two different deformation data processed from the same image. Examples of the processing include AI-based detection model difference determination and AI-based detection algorithm difference determination.

According to the information processing apparatus 100 according to the embodiments of the present disclosure described above, it is possible to properly grasp the deformation states of objects. That is, it is possible to accurately and easily generate deformation diagrams that record the deformation states.

### OTHER EMBODIMENTS

Embodiment(s) of the present disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has described exemplary embodiments, it is to be understood that some embodiments are not limited to the disclosed exemplary embodiments. The scope of the following claims is to be accorded the broadest interpretation so as to encompass all such modifications and equivalent structures and functions.

This application claims priority to Japanese Patent Application No. 2023-106430, which was filed on Jun. 28, 2023 and which is hereby incorporated by reference herein in its entirety.

What is claimed is:

1. An information processing apparatus comprising:
a processor; and
a memory containing instructions that, when executed by the processor, cause the processor to:
identify a common portion and a different portion between first deformation data of an object and second deformation data of the object different from the first deformation data, and
acquire, based on the common portion and the different portion, third deformation data having, as a legend classification, a deformation progress state between the first deformation data and the second deformation data.

2. The information processing apparatus according to claim 1, wherein the instructions further cause the processor to:
perform display control to cause a plurality of deformation correspondence candidates to be displayed.

3. The information processing apparatus according to claim 1, wherein the instructions further cause the processor to:
detect a common portion that is present in both a first deformation image of the object corresponding to the first deformation data and a second deformation image of the object corresponding to the second deformation data and that does not include a deformation, and
perform display control to cause the detected common portion, the first deformation data, and the second deformation data to be displayed in a superimposed manner.

4. The information processing apparatus according to claim 1, wherein
the first deformation data and the second deformation data are deformation data acquired at different times for the object.

5. An information processing method comprising:
identifying a common portion and a different portion between first deformation data of an object and second deformation data of the object different from the first deformation data; and
acquiring, based on the common portion and the different portion, third deformation data having, as a legend classification, a deformation progress state between the first deformation data and the second deformation data.

6. A non-transitory computer-readable storage medium storing a program that causes a computer to:
identifying a common portion and a different portion between first deformation data of an object and second deformation data of the object different from the first deformation data; and
acquiring, based on the common portion and the different portion, third deformation data having, as a legend classification, a deformation progress state between the first deformation data and the second deformation data.

7. A computer program product including a program that causes a computer to:
identifying a common portion and a different portion between first deformation data of an object and second deformation data of the object different from the first deformation data; and
acquiring, based on the common portion and the different portion, third deformation data having, as a legend classification, a deformation progress state between the first deformation data and the second deformation data.
